(19) United States
(12) Patent Application Publication
(10) Pub. No.: US 2012/0026163 A1
(43) Pub. Date: Feb. 2, 2012

(54) METHOD FOR DRIVING LIQUID CRYSTAL DISPLAY DEVICE

(75) Inventors: Jun Koyama, Kanagawa (JP); Shunpei Yamazaki, Tokyo (JP)

(73) Assignee: SEMICONDUCTOR ENERGY LABORATORY CO., LTD., Atsugi-shi (JP)

(21) Appl. No.: 13/191,031

(22) Filed: Jul. 26, 2011

(30) Foreign Application Priority Data
Jul. 29, 2010 (JP) 2010171162

(51) Int. Cl. G06T 15/00

(52) U.S. Cl. 345/419; 345/87

(57) ABSTRACT

Data of display data signals input to a plurality of display circuits are alternately switched between an image data for the left eye and an image data for the right eye every a plurality of frame periods; the plurality of display circuits are divided into a plurality of groups each including the display circuits in at least one row, and in each group, pulses of display selection signals are sequentially input Z (Z is a natural number greater than or equal to 3) times to the display circuits in the respective rows; and data of the display data signal input during a K-th (K is a natural number greater than or equal to 2) frame period and data of the display data signal input during a (K−1)-th frame period are compared. As a result, a color image and a black image are selectively displayed.

### TECHNICAL FIELD

An embodiment of the present invention relates to a method for driving a liquid crystal display device.

### BACKGROUND ART

In recent years, development of a liquid crystal display device which can display pseudo three-dimensional (3D) images has been progressed.

Examples of the liquid crystal display device which can show pseudo 3D images include a liquid crystal display device making viewers recognize two-dimensional (2D) images as 3D images by utilizing parallax between the left eye and the right eye. In an example of the liquid crystal display device, an image for the left eye (hereinafter, also referred to as a left-eye image) and an image for the right eye (hereinafter, also referred to as a right-eye image) are alternately displayed on a pixel portion, and a viewer sees the images with use of glasses provided with polarization shutters including liquid crystal for both eyes. When an image for the left eye is displayed as a display image, the polarization shutter for the right eye of the glasses is closed, and light incident on the right eye of the viewer is blocked. When an image for the right eye is displayed as a display image, the polarization shutter for the left eye of the glasses is closed, and light incident on the left eye of the viewer is blocked. As a result, 2D images can be seen as pseudo 3D images.

In addition, the following method (for example, Patent Document 1) is known. In each time of displaying a left-eye image and displaying a right-eye image, a unit frame period for displaying the image is divided into a plurality of subframe periods. A color of light emitted from a light unit (including a backlight) to a pixel circuit (also referred to as a display circuit) is changed every subframe, whereby a color image is displayed every unit frame period (this method is called a field sequential method). When a field sequential method is employed, for example, a color filter is not needed in the liquid crystal display device, and thus, light transmittance can be increased.

In addition, a method in which the left-eye images and the right-eye images are each displayed continuously over a plurality of frame periods is known (for example, Patent Document 2). By the above method, an interval between operations of switching between a polarization shutter for the left eye and a polarization shutter for the right eye of the glasses can be prolonged; thus, crosstalk can be suppressed even in the case of increasing the frame frequency.

### REFERENCE

[Patent Document 1] Japanese Published Patent Application No. 2003-259395
[Patent Document 2] Japanese Published Patent Application No. 2009-031523

### DISCLOSURE OF INVENTION

The conventional liquid crystal display device which can show pseudo 3D images has a problem of low image quality.

For example, in the case where an image is displayed by a field sequential method in the convention liquid crystal display device, color breakup is generated every subframe period by changing colors of light from the light unit, and thus, image quality is degraded.

An object of the present invention is to suppress degradation in image quality.

An embodiment of the present invention includes a plurality of display circuits arranged in X (X is a natural number greater than or equal to 2) rows and Y (Y is a natural number) columns, and a light unit which overlaps with the plurality of display circuits and includes a plurality of light-emitting diode groups each including a red light-emitting diode, a green light-emitting diode, and a blue light-emitting diode. X display selection signals are input to the display circuits in the respective rows, display data signals are input to the plurality of display circuits in accordance with pulses of the display selection signals, and the plurality of display circuits are brought into display states corresponding to data of the display data signals, whereby an image for the right eye and an image for the left eye are alternately displayed. When a display image is the left-eye image, light incident on the right eye of a viewer is blocked, and when a display image is the right-eye image, light incident on the left eye of the viewer is blocked.

Further, in an embodiment of the present invention, data of the display data signals input to the plurality of display circuits are alternately switched between an image data for the left eye and an image data for the right eye every a plurality of frame periods. The plurality of display circuits are divided into a plurality of groups each including the display circuits in at least one row, and in each group, pulses of display selection signals are sequentially input Z (Z is a natural number greater than or equal to 3) times to the display circuits in the respective rows in each group every frame period. Thus, speed of writing to the display circuit in each frame period is increased, whereby the frame frequency is easily increased.

Further, in an embodiment of the present invention, in the case where data of a display data signal input during a K-th (K is a natural number greater than or equal to 2) frame period and data of a display data signal input during a (K−1)-th frame period are for one eye (which means both of the data are for the left eye or the right eye), color images are displayed as follows. During the K-th frame period, light-emitting diodes in a plurality of light-emitting diode groups sequentially emit light every time a pulse of a display selection signal is input to display circuits in respective rows. In a light unit, regions which are determined by the plurality of light-emitting diode groups are sequentially turned to a lighting state. The display circuits in the rows to which the pulses of the display selection signal are input are sequentially irradiated with light from the light unit so that colors of the light emitted by the plurality of groups are different from each other and changed every time the pulse of the display selection signal is input. As a result, reduction in color breakup is achieved.

Further, according to an embodiment of the present invention, in the case where data of a display data signal input during the K-th frame period and data of a display data signal input during the (K−1)-th frame period are for eyes on different sides from each other (which means one of the data is for the left eye and the other of the data is for the right eye), a black image is displayed during the K-th frame period.

According to an embodiment of the present invention, generation of color breakup can be suppressed, for example; thus, degradation in images can be suppressed.

### BRIEF DESCRIPTION OF DRAWINGS

FIGS. 1A to 1C illustrate an example of a liquid crystal display device in Embodiment 1.

FIGS. 2A and 2B illustrate an example of a sequential circuit in a shift register in Embodiment 2.

FIGS. 3A and 3B illustrate an example of a shift register in Embodiment 2.

FIGS. 4A and 4B illustrate an example of a liquid crystal element in Embodiment 3.

FIGS. 5A to 5E are schematic cross-sectional views each illustrating a structural example of a transistor in Embodiment 4.

FIGS. 6A to 6E are schematic cross-sectional views illustrating an example of a method for manufacturing the transistor illustrated in FIG. 5A.

FIGS. 7A and 7B illustrate a structural example of an active matrix substrate of a liquid crystal display device in Embodiment 5.

FIGS. 8A and 8B illustrate another structural example of an active matrix substrate of a liquid crystal display device in Embodiment 5.

FIGS. 9A and 9B illustrate a structural example of a liquid crystal display device in Embodiment 5.

FIGS. 10A to 10D are schematic views illustrating examples of electronic devices in Embodiment 6.

### BEST MODE FOR CARRYING OUT THE INVENTION

Examples of embodiments describing the present invention will be described with reference to the drawings below. Note that the present invention is not limited to the following description because it will be easily understood by those skilled in the art that various changes and modifications can be made without departing from the spirit and scope of the present invention. Thus, the present invention should not be interpreted as being limited to the following description of the embodiments.

Note that the contents in different embodiments can be combined with one another as appropriate. In addition, the contents in different embodiments can be interchanged one another.

### Embodiment 1

In this embodiment, an example of a liquid crystal display device which displays images by switching a right-eye image and a left-eye image will be described.

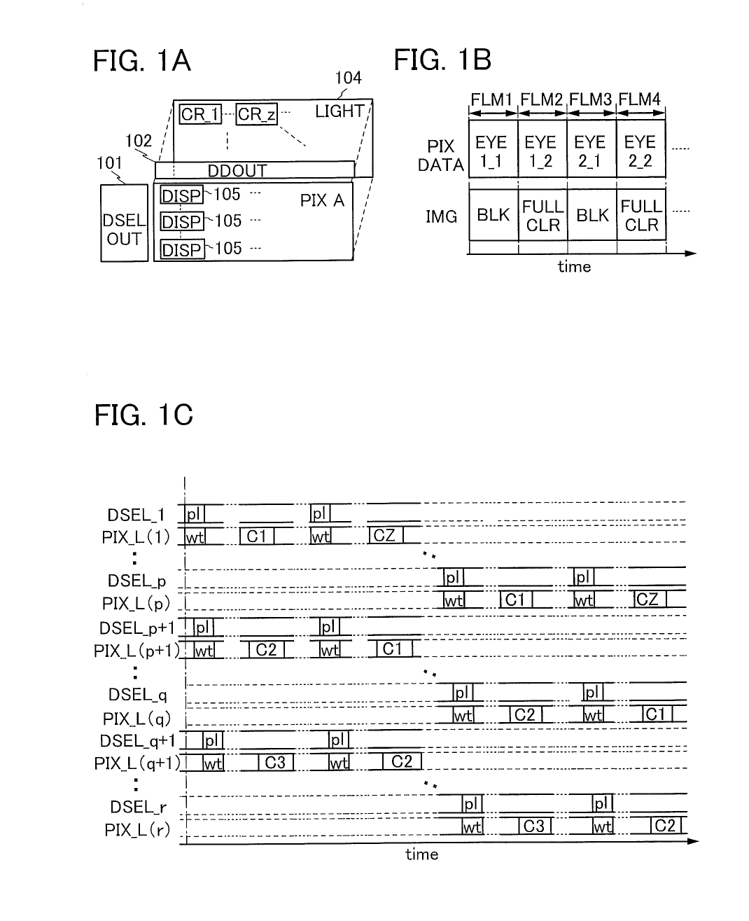

An example of the liquid crystal display device in this embodiment is described with reference to FIGS. 1A to 1C. FIGS. 1A to 1C illustrate the example of the liquid crystal display device in this embodiment.

First, an example of the structure of the liquid crystal display device of this embodiment is described with reference to FIG. 1A. FIG. 1A is a schematic view illustrating the structural example of the liquid crystal display device in Embodiment 1.

The liquid crystal display device illustrated in FIG. 1A includes a display selection signal output circuit (also referred to as DSELOUT) 101, a display data signal output circuit (also referred to as DDOUT) 102, a light unit 104, and a plurality of display circuits (also referred to as DISP) 105.

The display selection signal output circuit 101 has a function of outputting X (X is a natural number greater than or equal to 2) display selection signals (signals DSEL) which are pulse signals.

The display selection signal output circuit 101 includes a shift register, for example. The display selection signal output circuit 101 can output X display selection signals by output of X pulse signals from the shift register. A pulse of a start pulse signal is input to the shift register, and then the shift register starts outputting pulses of the X pulse signals sequentially. As the shift register in the display selection signal output circuit 101, for example, a shift register which outputs pulses of a plurality of output signals during one unit period is used, whereby pulses of a plurality of display selection signals can be output during the unit period. Alternatively, a plurality of shift registers are provided in the display selection signal output circuit 101, and pulse signals are output from the respective shift registers, whereby a plurality of display selection signals can be output. Further, the display selection signal output circuit 101 may be provided with a decoder instead of the shift register.

An image signal is input to the display data signal output circuit 102. The display data signal output circuit 102 has a function of generating Y (Y is a natural number) display data signals (a signal DD) which are voltage signals based on the input image signal and outputting the Y generated display data signals. Note that the number of the display data signals is not necessarily limited to Y.

Data of the image signal is switched between image data for the right eye of a viewer and image data for the left eye of the viewer in accordance with time. Thus, data of the plurality of display data signals are also switched between the image data for the right eye and the image data for the left eye in accordance with time.

The display data signal output circuit 102 includes a transistor, for example.

In the liquid crystal display device, the transistor has two terminals and a current control terminal that controls a current flowing between the two terminals with an applied voltage. Note that without limitation to the transistor, terminals where a current flowing therebetween is controlled are referred to as to current terminals. Two current terminals are also referred to as a first current terminal and a second current terminal.

Note that in this specification, terms with ordinal numbers, such as “first” and “second”, are used in order to avoid confusion among components, and the terms do not limit the components numerically.

In the liquid crystal display device, the transistor can be a field-effect transistor, for example. In a field-effect transistor, a first current terminal is one of a source and a drain, a second current terminal is the other of the source and the drain, and a current control terminal is a gate.

Voltage generally refers to a difference between potentials at two points (also referred to as a potential difference). However, values of both a voltage and a potential are represented using volt (V) in a circuit diagram or the like in some cases, so that it is difficult to discriminate between them. This is why in this specification, a potential difference between a potential at one point and a potential to be the reference (also referred to as the reference potential) is used as a voltage at the point in some cases unless otherwise specified.

The display data signal output circuit 102 can output data of an image signal as a display data signal when the transistor provided in the display data signal output circuit 102 is on. The transistor can be controlled by input of a control signal which is a pulse signal to the current control terminal.

In the case where the number of the columns (the number of Y) provided with the display circuits 105 is two or more, the display data signal output circuit 102 may output data of an image signal as a plurality of display data signals by selectively turning on or off a plurality of transistors. At this time, for example, a shift register is provided for the display data signal output circuit 102, a plurality of pulse signals whose number is greater than or equal to the number of the transistors are output from the shift register, and different pulse signals are input to the current control terminals of the plurality of transistors, whereby the plurality of transistors can be selectively turned on or off.

The light unit 104 is a light-emitting unit, which includes a plurality of light-emitting diode groups. Each of the plurality of light-emitting diode groups is provided with a plurality of light-emitting diodes (a light-emitting diode CR_1 to a light-emitting diode CR_z (z is a natural number greater than or equal to 3)) including a red light-emitting diode, a green light-emitting diode, and a blue light-emitting diode, and emitting light of different colors.

Note that as illustrated in FIG. 1A, for example, the plurality of light-emitting diode groups may be arranged in matrix. By arrangement of the plurality of light-emitting diodes in matrix, a state of the light unit 104 can be set in accordance with a plurality of regions which are determined by the plurality of light-emitting diode groups. For example, an emission region of the light unit 104 is divided into a plurality of regions, and the regions can each emit light of a different color.

The display selection signal output circuit 101, the display data signal output circuit 102, and the light unit 104 are controlled by, for example, a control circuit. For example, the liquid crystal display device may be provided with a control circuit. With the control circuit, for example, output timing of a pulse of the display selection signal of the display selection signal output circuit 101, output timing of a display data signal of the display data signal output circuit 102, and lighting timing of the plurality of light-emitting diodes of the light unit 104 can be controlled.

The plurality of display circuits 105 each overlap with the light unit 104. The plurality of display circuits 105 are arranged in X rows by Y columns in a pixel portion. The pixel portion displays an image. One pixel includes at least one display circuit 105.

Different display selection signals are input to the plurality of display circuits 105 in the respective rows, and display data signals are input to the plurality of display circuits 105 in accordance with the input display selection signal. The plurality of display circuits 105 each has a function of changing their display states in accordance with data of the input display data signal.

The plurality of display circuits 105 each include a display selection transistor and a liquid crystal element, for example.

The display selection transistor has a function of selecting whether data of a display data signal is input to the liquid crystal element.

The liquid crystal element has a function of changing its display state corresponding to data of a display data signal by input of the data of the display data signal in accordance with the display selection transistor and control of light transmittance.

As a display method of the liquid crystal display device, a TN (twisted nematic) mode, an IPS (in-plane-switching) mode, a STN (super twisted nematic) mode, a VA (vertical alignment) mode, an ASM (axially symmetric aligned micro-cell) mode, an OCB (optically compensated birefringence) mode, an FLC (ferroelectric liquid crystal) mode, an AFLC (antiferroelectric liquid crystal) mode, an MVA (multi-domain vertical alignment) mode, a PVA (patterned vertical alignment) mode, an ASV (advanced super view) mode, a FFS (fringe field switching) mode, or the like may be used.

Next, as an example of a method for driving the liquid crystal display device of this embodiment, an example of a method for driving the liquid crystal display device illustrated in FIG. 1A is described with reference to FIGS. 1B and 1C. FIGS. 1B and 1C are timing charts for describing an example of the driving method of the liquid crystal display device illustrated in FIG. 1A.

In the liquid crystal display device illustrated in FIG. 1A, data of the display data signal is switched every plural frame periods between the image data for the left eye and the image data for the right eye, and during the continuous plural frame periods, images for one eye are displayed.

In the case where data of the display data signal input to the display circuit 105 during a K-th (K is a natural number greater than or equal to two) frame period and data of the display data signal input to the display circuit 105 during a (K−1)-th frame period are for one eye, a color image is displayed by the plurality of display circuits 105. Here, a full-color image is displayed.

In the case where data of the display data signal input to the display circuit 105 during the K-th frame period and data of the display data signal input to the display circuit 105 during the (K−1)-th frame period are for the eyes on the different sides from each other, a black image is displayed by the plurality of display circuits 105. For example, a black image can be displayed by a method by which data of the display data signal is made to be data for black or a method by which the light unit 104 is turned off. Note that the black image includes an image which is judged as a black image by a viewer.

For example, as illustrated in FIG. 1B, in a series of a plurality of frame periods (frame periods FLM1 to FLM4), data of a display data signal which is data EYE1_{—1} for one of the left eye and the right eye (also referred to as PIXDATA) is input to the display circuit 105 during the frame period FLM1. In this case, since the data EYE1_1 is data for the different eye from the eye for which data of a display data signal input during the previous period is, a black image (also referred to as BLK) is displayed as a display image (also referred to as IMG).

Next, data of a display data signal which is data EYE1_2 for one of the left eye and the right eye is input to the display circuit 105 during the frame period FLM2. In this case, since the data EYE1_2 is data for one eye for which the data EYE1_1 during the frame period FLM1 is, a full-color image (also referred to as FULLCLR) is displayed as a display image.

Next, data of a display data signal which is data EYE2_1 for the other of the left eye and the right eye is input to the display circuit 105 during the frame period FLM3. In this case, since the data EYE2_1 is data for the different eye from the eye for which the data EYE1_2 during the frame period FLM2 is, a black image is displayed as a display image.

Next, data of a display data signal which is data EYE2_2 for the other of the left eye and the right eye is input to the display circuit 105 during the frame period FLM4. In this case, since the data EYE2_2 is data for one eye for which the data EYE2_1 during the frame period FLM3 is, a full-color image is displayed as a display image.

When the display image is a left-eye image, light incident on the right eye of a viewer is blocked, and when the display image is a right-eye image, light incident on the left eye of the viewer is blocked. For example, the viewer wears glasses provided with polarization shutters corresponding to both eyes of the viewer, and the polarization state of the polarization shutters is set in accordance with kinds of display images, whereby light incident on the right eye or the left eye of the viewer can be blocked. For example, when the display image is a left-eye image, light incident on the right eye of the viewer is blocked, and when the display image is a right-eye image, light incident on the left eye of the viewer is blocked; therefore, the viewer can see pseudo 3D images.

Further, an example of a driving method of a liquid crystal display device in each frame period is described.

During each frame period of the liquid crystal display device illustrated in FIG. 1A, the plurality of display circuits 105 are divided into a plurality of groups each including display circuits provided in one or more rows, and in each of the plurality of groups, pulses of display selection signals are input Z (Z is a natural number greater than or equal to 3) times to the display circuits 105 in respective rows. For example, in the case where the display selection signal output circuit 101 includes a shift register, a pulse of a start pulse signal is input to the shift register, and pulses of a plurality of pulse signals of the shift register are sequentially output. Moreover, another pulse of a start pulse signal is input while the pulses of the plurality of pulse signals of the shift register are sequentially output, whereby pulses of display selection signals can be input Z times to the display circuits 105 in respective rows in the plurality of groups.

In the case where data of a display data signal input to the display circuits 105 during the K-th frame period is data for one eye for which data of a display data signal input to the display circuits 105 during the (K−1)-th frame period, a full-color image is displayed as follows. During the K-th frame period, light-emitting diodes in a plurality of light-emitting diode groups sequentially emit light every time a pulse of a display selection signal is input to the display circuits 105 in respective rows; regions of the light unit 104, which are determined by the plurality of light-emitting diode groups, are sequentially turned to a lighting state; and the display circuits 105 in the rows to which the pulses of the display selection signal are input are sequentially irradiated with light from the light unit 104 so that colors of the light emitted by the plurality of groups are different from each other and changed every time the pulse of the display selection signal is input.

For example, during the frame period for displaying a full-color image, the display circuits 105 are divided into three groups as illustrated in FIG. 1C. A first group includes the display circuit 105 in a first row (also referred to as a display circuit PIX_L(1)) to the display circuit 105 in a p-th row (p is a natural number greater than or equal to 3) (also referred to as a display circuit PIX_L(p)). A second group includes the display circuit 105 in a (p+1)-th row (also referred to as a display circuit PIX_L(p+1)) to the display circuit 105 in a q-th row (q is a natural number greater than or equal to (p+3)) (also referred to as a display circuit PIX_L(q)). A third group includes the display circuit 105 in a (q+1)-th row (also referred to as a display circuit PIX_L(q+1)) to the display circuit 105 in a r-th row (r is a natural number greater than or equal to (q+3)) (also referred to as a display circuit PIX_L(r)).

In each of the first to third groups, pulses (pl) of display selection signals corresponding to the display circuits 105 in the respective rows (a display selection signal (a signal DSEL_1) corresponding to the display circuit 105 in the first row to a display selection signal (a signal DSEL_r) corresponding to the display circuit 105 in the r-th row) are input Z times to the display circuits 105 sequentially, i.e., the pulse is first input to the display circuit 105 in the beginning row (the display circuit 105 in the first row, the display circuit 105 in the (p+1)-th row, and the display circuit 105 in the (q+1)-th row) in each group. Timing of the pulses of the r display selection signals is different among the r display selection signals.

A display data signal is input to the display circuit 105 every input of a pulse of a display selection signal, and the display circuit 105 is brought into a writing state (a state wt). Then, one or more of the light-emitting diodes in the light-emitting diode groups emit light, so that part of the regions of the light unit 104 is brought into a lighting state. The display circuit 105 in the writing state is irradiated with light from the light unit 104, so that the display circuit is brought into a display state corresponding to data of the written display data signal and irradiation light. Note that the display circuits 105 in plural rows to which pulses of the display selection signals are input may be irradiated with light from the light unit 104 at the same timing.

In terms of the display circuits 105 in the same row, a color of light emitted from each region of the light unit 104 after input of a pulse of the display selection signal changes every input of a pulse of the display selection signal. In addition, in terms of a plurality of groups, colors of light emitted from respective regions of the light unit 104 to the display circuits 105 to which pulses of the display selection signals are concurrently input in a certain period are different among groups. Furthermore, in each group, in the case where one display circuit 105 is irradiated with light from the light unit 104 while another display circuit 105 adjacent to the one display circuit 105 is irradiated with light from the light unit 104, light emitted from the light unit 104 to both the display circuits 105 has the same color. Thus, in the case where data of the display data signal written to the display circuit 105 is data for a specific color, light of a different color from that of the data can be prevented from being emitted to the display circuits 105 from the light unit 104.

For example, in the first group, after a pulse of the display selection signal is input first, the display circuits 105 are brought into a display state corresponding to a first color (a state C1) by irradiating the display circuits 105 to which the pulse of the display selection signal is input with light of the first color which is emitted from part of the regions of the light unit 104. Then, the display state of the display circuits 105 is changed every input of a pulse of the display selection signal. That is, the display state is changed into a display state corresponding to a second color after input of the next pulse. After sequential change, the display state is a display state corresponding to a (Z−1)-th color (a state CZ−1), and then changed into a display state corresponding to a Z-th color (a state CZ).

In the second group, after a pulse of the display selection signal is input first, the display circuits 105 are brought into a display state corresponding to a second color (a state C2) by irradiating the display circuits 105 to which the pulse of the display selection signal is input with light of the second color which is emitted from part of the regions of the light unit 104. Then, the display state of the display circuits 105 is changed every input of a pulse of the display selection signal. That is, the display state is changed into a display state corresponding to a third color after input of the next pulse. After sequential change, the display state is a display state corresponding to the Z-th color (a state CZ), and then changed into a display state corresponding to the first color.

In the third group, after a pulse of the display selection signal is input first, the display circuits 105 are brought into a display state corresponding to a third color (a state C3) by irradiating the display circuits 105 to which the pulse of the display selection signal is input with light of the third color which is emitted from part of the regions of the light unit 104. Then, the display state of the display circuits 105 is changed every input of a pulse of the display selection signal. That is, the display state is changed into a display state corresponding to a fourth color (a state C4) after input of the next pulse. After sequential change, the display state is a display state corresponding to the Z-th color (a state CZ), changed into a display state corresponding to the first color, and changed into a display state corresponding to the second color.

Note that as the first to Z-th colors, for example, red, green, and blue; or a combination including any of red, green, blue, cyan, magenta, yellow, and the like can be given. Cyan can be expressed by emitting light from a green light-emitting diode and a blue light-emitting diode, for example. Magenta can be expressed by emitting light from a red light-emitting diode and a blue light-emitting diode, for example. Yellow can be expressed by emitting light from a red light-emitting diode and a green light-emitting diode, for example. Note that there is no particular limitation on the emission order of the first to Z-th colors.

When the light unit 104 is lit every time data is input to the display circuits 105 by switching between image data for the left eye and image data for the right eye, the number of colors of light emitted concurrently by the light-emitting diodes in the light-emitting diode group may be alternately changed between one color and two colors.

For example, in the case where the light unit 104 is lit during a period in which a full-color image for one of the right eye and the left eye is displayed, one light-emitting diode in the light-emitting diode group emits light, and color of light from the light unit 104 is red, green, and blue.

Next, in the case where the light unit 104 is lit during a period in which a full-color image for the other of the right eye and the left eye is displayed, one light-emitting diode in the light-emitting diode group emits light, and color of light from the light unit 104 is red, green, and blue.

Next, in the case where the light unit 104 is lit during a period in which a full-color image for one of the right eye and the left eye is displayed, two light-emitting diodes in the light-emitting diode group emit light concurrently, and color of light from the light unit 104 is cyan, magenta, and yellow.

Next, in the case where the light unit 104 is lit during a period in which a full-color image for the other of the right eye and the left eye is displayed, two light-emitting diodes in the light-emitting diode group emit light concurrently, and color of light from the light unit 104 is cyan, magenta, and yellow.

As described above, in the case where the light unit 104 is lit every time the data is alternately changed between the image data for the left eye and the image data for the right eye, the number of colors of light emitted concurrently by the light-emitting diodes are switched between one color and two colors alternately. Thus, the range of color which can be expressed by red, green, and blue can be kept, and luminance of a display image can be improved.

In the case where data of the display data signal input to the display circuit 105 during the K-th frame period is data for the different eye from the eye for which data of the display data signal input to the display circuit 105 during the (K−1)-th frame period is, a display data signal including data of a black image is input to the plurality of display circuits 105 during the K-th frame period, for example, in order to display a black image.

Further, in the case where data of the display data signal input to the display circuit 105 during the K-th frame period is data for the different eye from the eye for which data of the display data signal input to the display circuit 105 during the (K−1)-th frame period is, the light unit 104 may be turned off during the K-th frame period, so that a black image is displayed.

Further, in the case where data of the display data signal input to the display circuit 105 during the K-th frame period is data for the different eye from the eye for which data of the display data signal input to the display circuit 105 during the (K−1)-th frame period is, a black image may be displayed during the K-th frame period by inputting a display data signal including data of a black image to the plurality of display circuits 105 and turning off the light unit 104.

While operation of writing data of the display data signal to the display circuits 105 in the (K−1)-th frame period is performed in the display circuits 105 in a W-th row (W is a natural number greater than or equal to 2 and less than or equal to X), operation of writing data of the display data signal to the display circuits 105 in the K-th frame period may be started in the display circuits 105 in a (W−1)-th row. Thus, the frame frequency of the liquid crystal display device can be increased.

As described with reference to FIGS. 1A to 1C, in the example of the liquid crystal display device of this embodiment, data of the display data signal is switched between image data for the left eye and image data for the right eye alternately every successive frame periods so that a left-eye image or a right-eye image is displayed. When a display image is a left-eye image, light incident on the right eye of a viewer is blocked, and when a display image is a right-eye image, light incident on the left eye of the viewer is blocked.

Further, the example of the liquid crystal display device of this embodiment has the following structure. In the case where data of the display data signal input during the K-th frame period is data for one eye for which data of the display data signal input during the (K−1)-th frame period is, a color image is displayed; and in the case where data of the display data signal input during the K-th frame period is data for the different eye from the eye for which data of the display data signal input during the (K−1)-th frame period is, a black image is displayed. With the above structure, flicker in an image due to switching of the left-eye image and the right-eye image can be reduced; thus, image quality can be improved.

Further, in the example of the liquid crystal display device of this embodiment, the plurality of display circuits are divided into a plurality of groups in the row direction, and in each group, pulses of display selection signals are sequentially input Z times to the display circuits in the respective rows in each frame period.

Further, in the example of the liquid crystal display device of this embodiment, in the case where data of the display data signal input during the K-th (K is a natural number greater than or equal to 2) frame period is data for one eye for which data of the display data signal input during the (K−1)-th frame period is, a color image is displayed as follows. During the K-th frame period, the light-emitting diodes in the plurality of light-emitting diode groups sequentially emit light every time a pulse of the display selection signal is input to the display circuits in respective rows. In the light unit, regions which are determined by the plurality of light-emitting diode groups are sequentially turned to a lighting state. The display circuits in the rows to which the pulses of the display selection signal are input are sequentially irradiated with light from the light unit so that colors of the light emitted by the plurality of groups are different from each other and changed every time the pulse of the display selection signal is input.

With the above structure, since operation of writing data of the display data signal to the display circuits can be performed concurrently on the plurality of groups, time of writing operation for all the display circuits can be shortened. Thus, the frame frequency can be increased, and a reduction in color breakup can be achieved.

Further, with the above structure, in each group, while the display circuits in respective rows is irradiated with light from the light unit, data of a display data signal can be written to the display circuits in another row, whereby time of writing data for all the display circuits can be shortened. Thus, the frame frequency can be increased, and a reduction in color breakup can be achieved.

Furthermore, with the above structure, an image with colors which are different among the plurality of groups is displayed, whereby the number of regions in which color breakup is generated can be decreased. Thus, color breakup can be reduced as a whole.

According to the above, image quality of a display image can be improved.

### Embodiment 2

In this embodiment, an example of a shift register included in a display selection signal output circuit in the liquid crystal display device of the above embodiment will be described. Note that the shift register described in this embodiment is just an example, and a structure of a shift register which can be applied to the display selection signal output circuit in the liquid crystal display device of the above embodiment is not limited to the shift register described in this embodiment. A shift register with a different structure and a circuit other than the shift register (e.g., a decoder or the like) can be applied to the display selection signal output circuit in the liquid crystal display device of the above embodiment.

An example of a shift register of this embodiment includes sequential circuits of plural stages (also referred to as FFs).

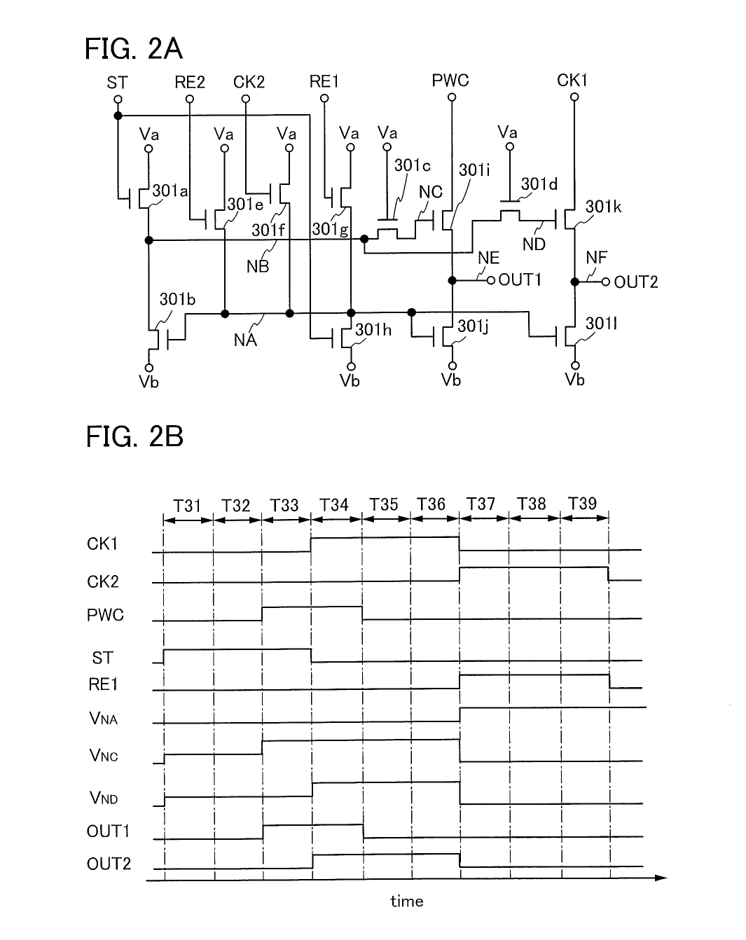

One of the sequential circuits is described with reference to FIGS. 2A and 2B. FIGS. 2A and 2B illustrate the sequential circuit in the shift register of this embodiment.

First, a circuit configuration example of the sequential circuit is described with reference to FIG. 2A. FIG. 2A is a circuit diagram illustrating a circuit configuration example of the sequential circuit.

To the sequential circuit illustrated in FIG. 2A, a set signal ST (a signal ST), a reset signal RE1 (a signal RE1), a reset signal RE2 (a signal RE2), a clock signal CK1 (a signal CK1), a clock signal CK2 (a signal CK2), and a pulse width control signal PWC (a signal PWC) are input. In addition, the sequential circuit outputs a signal OUT1 and a signal OUT2.

Note that a pulse width of the pulse width control signal PWC is smaller than a pulse width of the clock signal CK1 or the clock signal CK2.

The reset signal RE2 is a signal which makes the sequential circuit a reset state before a pulse signal of each output signal is output every frame period, for example.

The sequential circuit illustrated in FIG. 2A includes a transistor 301a, a transistor 301b, a transistor 301c, a transistor 301d, a transistor 301e, a transistor 301f, a transistor 301g, a transistor 301h, a transistor 301i, a transistor 301j, a transistor 301k, and a transistor 301l.

In the sequential circuit illustrated in FIG. 2A, each of the transistors 301a to 301l is a field-effect transistor.

A voltage Va is input to one of a source and a drain of the transistor 301a, and the set signal ST is input to a gate of the transistor 301a.

One of a source and a drain of the transistor 301b is connected to the other of the source and the drain of the transistor 301a, and a voltage Vb is input to the other of the source and the drain of the transistor 301b.

One of a source and a drain of the transistor 301c is connected to the other of the source and the drain of the transistor 301a, and the voltage Va is input to a gate of the transistor 301c.

One of a source and a drain of the transistor 301d is connected to the other of the source and the drain of the transistor 301a, and the voltage Va is input to a gate of the transistor 301d.

The voltage Va is input to one of a source and a drain of the transistor 301e, the other of the source and the drain of the transistor 301e is connected to a gate of the transistor 301b, and the signal RE2 is input to a gate of the transistor 301e.

The voltage Va is input to one of a source and a drain of the transistor 301f, the other of the source and the drain of the transistor 301f is connected to the gate of the transistor 301b, and the signal CK2 is input to a gate of the transistor 301f.

The voltage Va is input to one of a source and a drain of the transistor 301g, the other of the source and the drain of the transistor 301g is connected to the gate of the transistor 301b, and the signal RE1 is input to a gate of the transistor 301g.

One of a source and a drain of the transistor 301h is connected to the other of the source and the drain of the transistor 301g, the voltage Vb is input to the other of the source and the drain of the transistor 301h, and the set signal ST is input to a gate of the transistor 301h.

The signal PWC is input to one of a source and a drain of the transistor 301i, and a gate of the transistor 301i is connected to the other of the source and the drain of the transistor 301c.

One of a source and a drain of the transistor 301j is connected to the other of the source and the drain of the transistor 301l, and the voltage Vb is input to the other of the source and the drain of the transistor 301j.

The signal CK1 is input to one of a source and a drain of the transistor 301k, and a gate of the transistor 301k is connected to the other of the source and the drain of the transistor 301d.

One of a source and a drain of the transistor 301l is connected to the other of the source and the drain of the transistor 301k, the voltage Vb is input to the other of the source and the drain of the transistor 301l, and a gate of the transistor 301l is connected to the gate of the transistor 301b.

Note that one of the voltage Va and the voltage Vb is a high power supply voltage Vdd, and the other is a low power supply voltage Vss. The high power supply voltage Vdd is a voltage the value of which is relatively higher than that of the low power supply voltage Vss. The low power supply voltage Vss is a voltage the value of which is relatively lower than that of the high power supply voltage Vdd. The value of the voltage Va and the value of the voltage Vb might interchange depending, for example, on the conductivity type of the transistor. The difference between the voltage Va and the voltage Vb is a power supply voltage.

In FIG. 2A, a portion where the gate of the transistor 301b, the one of the source and the drain of the transistor 301h, the gate of the transistor 301j, and the gate of the transistor 301l are connected to each other is referred to as a node NA.

In addition, a portion where the other of the source and the drain of the transistor 301a, the one of the source and the drain of the transistor 301b, and the one of the source and the drain of the transistor 301c are connected to each other is referred to as a node NB.

A portion where the other of the source and the drain of the transistor 301c and the gate of the transistor 301i are connected to each other is referred to as a node NC.

A portion where the other of the source and the drain of the transistor 301d and the gate of the transistor 301k are connected to each other is referred to as a node ND.

A portion where the other of the source and the drain of the transistor 301i and the one of the source and the drain of the transistor 301j are connected to each other is referred to as a node NE.

A portion where the other of the source and the drain of the transistor 301k and the one of the source and the drain of the transistor 301l are connected to each other is referred to as a node NF.

Note that in the sequential circuit in the shift register of this embodiment, the transistor 301c is not necessarily provided; however, with the transistor 301c, voltage at the node NB can be prevented from increasing to a voltage higher than the high power supply voltage Vdd.

Note that in the sequential circuit in the shift register of this embodiment, the transistor 301d is not necessarily provided; however, with the transistor 301d, voltage at the node NB can be prevented from increasing to a voltage higher than the high power supply voltage Vdd.

An example of operation of the sequential circuit illustrated in FIG. 2A is described with reference to FIG. 2B. FIG. 2B is a timing chart for describing the example of the operation of the sequential circuit in FIG. 2A. For example, the transistors 301a to 301l in the sequential circuit in FIG. 2A are all n-channel transistors, the threshold voltages of the transistor 301l and the transistor 301k are the same voltage Vth, and the high power supply voltage Vdd and the low power supply voltage Vss are input as the voltage Va and the voltage Vb, respectively. The duty ratio of each of the clock signal CK1 and the clock signal CK2 is 25%, the duty ratio of the signal PWC is 33%, and the pulse width of each of the clock signal CK1 and the clock signal CK2 is 1.5 times as large as the pulse width of the signal PWC.

To the sequential circuit illustrated in FIG. 2A, a pulse of the signal ST is input during periods T31 to T33, so that the sequential circuit is in a set state.

For example, in the period T31, the transistor 301h is turned on, so that a voltage V_{NA} of the node NA becomes equivalent to the value of the voltage Vb, and the transistor 301j and the transistor 301l are turned off.

Further, during the period T31, the transistor 301a, the transistor 301c, and the transistor 301d are turned on, and the transistor 301b is turned off, so that the voltage V_{NB} of the node NB is increased to the value equivalent to the voltage Va, and then, the transistor 301a is turned off.

During the period T33 and a period T34, a pulse of the signal PWC is input. In the period T33, with capacitive coupling due to parasitic capacitance generated between the gate of the transistor 301i and the other of the source and the drain thereof, the voltage V_{NC} of the node NC is increased to a value which is higher than the sum of the voltage Va and the voltage Vth, i.e., Va+Vth+Vx (Vx is a given value), so that the transistor 301i is turned on. The sequential circuit illustrated in FIG. 2A, accordingly, outputs a pulse of the signal OUT1 in accordance with the voltage of the node NE during the period T33 and a period T34.

During the periods T34 to T36, the signal CK1 is set to a high level. In the period T34, with capacitive coupling due to parasitic capacitance generated between the gate of the transistor 301k and the other of the source and the drain thereof, the voltage of the node ND is increased to a value which is higher than the sum of the voltage Va and the voltage Vth, i.e., Va+Vth+Vx, so that the transistor 301k is turned on. The sequential circuit illustrated in FIG. 2A, accordingly, outputs a pulse of the signal OUT2 in accordance with the voltage of the node NF during the periods T34 to T36.

After that, the sequential circuit illustrated in FIG. 2A is in a reset state by input of a pulse of the signal RE1 during periods T37 to T39. In the period T37, for example, the transistor 301g is turned on, whereby the voltage V_{NA} of the node NA becomes a value equivalent to that of the voltage Va, and then the transistor 301j and the transistor 301l are turned on. During the periods T37 to T39, the signal CK2 is set to a high level. In the period T37, the transistor 301f is turned on, whereby each of the voltages of the node NC and the node ND becomes a value equivalent to that of the voltage Vb, and then the transistor 301i and the transistor 301j are turned off. Thus, during the periods T37 to T39, the signal OUT1 and the signal OUT2 are set to a low level. That is an example of the operation of the sequential circuit in FIG. 2A.

As described with reference to FIG. 2B, the sequential circuit illustrated in FIG. 2A is set to be in a set state by input of the set signal, and then pulses of the signal OUT1 and the signal OUT2 are output. When the reset signal is input, the sequential circuit is in a reset state, and then the signal OUT1 and the signal OUT2 are set to a low level.

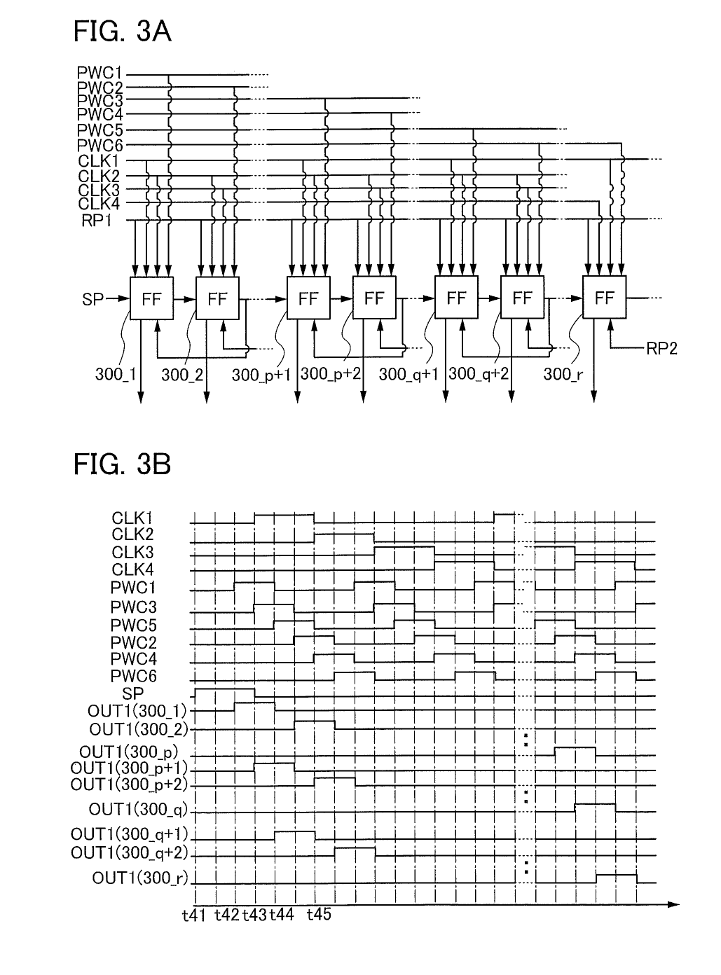

Moreover, an example of a shift register including the sequential circuit illustrated in FIG. 2A is described with reference to FIGS. 3A and 3B. FIGS. 3A and 3B are diagrams for describing the shift register in this embodiment.

First, a structural example of the shift register including the sequential circuit illustrated in FIG. 2A is described with reference to FIG. 3A. FIG. 3A is a block diagram illustrating an example of a structure of the shift register in this embodiment.

The shift register illustrated in FIG. 3A includes sequential circuits of r stages (sequential circuits 300_1 to 300_r) described with reference to FIG. 2A.

To the shift register illustrated in FIG. 3A, a start pulse signal SP (a signal SP), a clock signal CLK1 (a signal CLK1) to a clock signal CLK4 (a signal CLK4), a pulse width control signal PWC1 (a signal PWC1) to a pulse width control signal PWC6 (a signal PWC6), and a reset pulse signal RP1 (a signal RP1) are input.

The duty ratio of each of the signal CLK1 to the signal CLK4 is 25%, and the signal CLK1 to the signal CLK4 are sequentially delayed by a quarter of one cycle period.

Note that as a signal CK1 and a signal CK2 in each sequential circuit, any of two clock signals CLK1 to CLK4 can be used. The clock signals of the same combination are not input to the sequential circuits adjacent to each other, and the input two clock signals are delayed by a quarter of one cycle period. By using the plurality of clock signals, the speed of a signal output operation of the shift register can be increased.

Each of the pulse width control signal PWC1 to the pulse width control signal PWC6 is a pulse signal and has a duty ratio of 33%. The pulse width control signal PWC1 to the pulse width control signal PWC6 are sequentially delayed by a sixth of one cycle period.

Note that as a signal PWC in each sequential circuit, any one of the pulse width control signal PWC1 to the pulse width control signal PWC6 can be used. The same pulse width control signal is not input to the sequential circuits adjacent to each other. Further, the r sequential circuits are divided into a plurality of groups each of which include sequential circuits of a plurality of successive stages, and different pulse width control signals are input to the respective groups of the sequential circuits. With use of the plurality of pulse width control signals, a pulse of an output signal can be controlled in each group including sequential circuits of a plurality of successive stages.

For example, in a sequential circuit 300_1 of a first stage to a sequential circuit 300_{—}p of a p-th stage, the signal PWC1 is input to the sequential circuits of odd-numbered stages, and the signal PWC2 is input to the sequential circuits of even-numbered stages. In a sequential circuit 300_{—}p+1 of a (p+1)-th stage to a sequential circuit 300_{—}q of a q-th stage, the signal PWC3 is input to the sequential circuits of odd-numbered stages, and the signal PWC4 is input to the sequential circuits of even-numbered stages. In a sequential circuit 300_{—}q+1 of a (q+1)-th stage to a sequential circuit 300_{—}r of an r-th stage, the signal PWC5 is input to the sequential circuits of odd-numbered stages, and the signal PWC6 is input to the sequential circuits of even-numbered stages.

Further, the signal SP is input as the signal ST to the gate of the transistor 301a and the gate of the transistor 301h in the first sequential circuit 300_1.

The gate of the transistor 301a and the gate of the transistor 301h in a sequential circuit 300_H+1 (H is a natural number less than or equal to (r−2)) of a (H+1)-th stage are connected to the other of the source and the drain of the transistor 301k in a sequential circuit 300_H of a H-th stage. At this time, the signal OUT2 of the sequential circuit 300_H is the signal ST in the sequential circuit 300_H+1.

The other of the source and the drain of the transistor 301k in the sequential circuit 300_H+1 is connected to the gate of the transistor 301g in the sequential circuit 300_H. At that time, the signal OUT2 in the sequential circuit 300_H+1 is the signal RE1 in the sequential circuit 300_H.

Further, a reset pulse signal RP2 (a signal RP2) is input as the signal RE1 to the gate of the transistor 301g in the sequential circuit 300_{—}r of the r-th stage. For example, a sequential circuit with the structure illustrated in FIG. 2A is provided as a dummy sequential circuit, and the signal OUT1 of the dummy sequential circuit can be used as the signal RP2.

Further, an example of a driving method of the shift register in FIG. 3A is described with reference to FIG. 3B. FIG. 3B is a timing chart for describing an example of a driving method of the shift register in FIG. 3A. Here, the pulse width of each of the signal CLK1 to the signal CLK6 is 1.5 times as large as the pulse width of each of the signal PWC1 to the signal PWC6, as an example.

As operation of the shift register illustrated in FIG. 3A, pulses of the signal OUT1 and the signal OUT2 are sequentially output from the sequential circuits (sequential circuits 300_1 to 300_{—}r) in accordance with the signals CLK1 to the signal CLK4, the signal PWC1 to the signal PWC6, and the signal SP. For example, during a period from time t41 to time t43, a pulse of the signal SP is input to the sequential circuit 300_1; during a period from time t42 to time t44, a pulse of the signal PWC1 is generated; and during a period from the time t43 to time t45, a pulse of the signal CLK1 is generated. As a result, during a period from the time t42 to the time t44, the sequential circuit 300_1 outputs a pulse of the signal OUT1. Note that before a pulse of the signal SP is input, a pulse of the signal RP1 may be input to each sequential circuit, whereby each sequential circuit may be set to be in a reset state.

As described with reference to FIGS. 2A and 2B and FIGS. 3A and 3B, the shift register of this embodiment includes the sequential circuits of the plurality of stages. Each of the plurality of sequential circuits includes a first transistor, a second transistor, and a third transistor. The first transistor has a gate to which a set signal is input and a function of controlling whether to turn on the second transistor in accordance with the set signal. The second transistor has a source and a drain one of which is supplied with a pulse control signal and a function of controlling whether to set the voltage of an output signal from the sequential circuit to a value corresponding to the voltage of the pulse control signal. The third transistor has a gate to which a reset signal is input and a function of controlling whether to turn off the second transistor in accordance with the reset signal.

Moreover, the shift register of this embodiment can be used for the display selection signal output circuit in the liquid crystal display device of the above embodiment. With the above structure, for example, a pulse of a signal SP is generated plural times in one frame period, whereby a pixel portion is divided into groups constituted by display circuits in plural rows, and pulses of the display selection signals can be output sequentially in each group. Thus, even in the case where pulses of the display selection signals are output in each group, stripes generated at boundaries of the groups due to divisions can be suppressed, and image quality can be further improved.

The operation of the display selection signal output circuit is not limited to generation of a pulse of the signal SP plural times in one frame period. For example, a plurality of shift registers having the above structure are provided in the display selection signal output circuit, and pulses of the signals SP are generated from different shift registers in each group including the display circuits in plural rows, whereby pulses of the display selection signals can be sequentially output in each group including the display circuits in the plural rows.

In the case where the display selection signal output circuit in the liquid crystal display device in the above embodiment includes a shift register, with use of the shift register of this embodiment, the display selection signal output circuit in the liquid crystal display device in the above embodiment can be formed.

### Embodiment 3

In this embodiment, an example of a display circuit in the liquid crystal display device described in the above embodiment will be described.

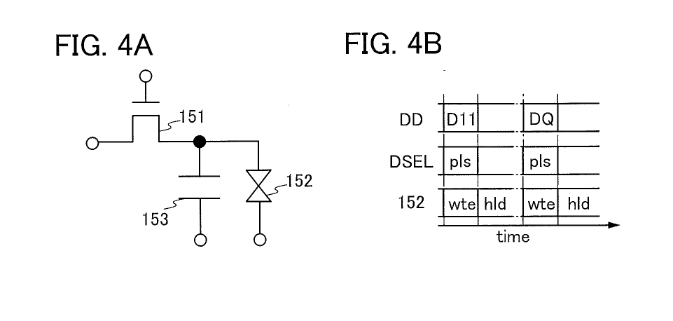

An example of the display circuit in this embodiment will be described with reference to FIGS. 4A and 4B. FIGS. 4A and 4B are diagrams for explaining an example of the display circuit in this embodiment.

First, a configuration example of the display circuit in this embodiment is described with reference to FIG. 4A. FIG. 4A illustrates the configuration example of the display circuit in this embodiment.

The display circuit illustrated in FIG. 4A includes a transistor 151, a liquid crystal element 152, and a capacitor 153.

In the display circuit in FIG. 4A, the transistor 151 is a field-effect transistor.

In the liquid crystal display device, a liquid crystal element includes a first display electrode, a second display electrode, and a liquid crystal layer. The light transmittance of the liquid crystal layer changes in accordance with a voltage applied between the first display electrode and the second display electrode.

Further, in the liquid crystal display device, the capacitor includes a first capacitor electrode, a second capacitor electrode, and a dielectric layer overlapping with the first capacitor electrode and the second capacitor electrode. The capacitor accumulates electric charge in accordance with a voltage applied between the first capacitor electrode and the second capacitor electrode.

A signal DD is input to one of a source and a drain of the transistor 151, and a signal DSEL is input to a gate of the transistor 151.

The first display electrode of the liquid crystal element 152 is electrically connected to the other of the source and the drain of the transistor 151. A voltage Vc is input to the second display electrode of the liquid crystal element 152. The level of the voltage Vc can be set as appropriate.

The first capacitor electrode of the capacitor 153 is electrically connected to the other of the source and the drain of the transistor 151. The voltage Vc is input to the second capacitor electrode of the capacitor 153.

Next, the components of the display circuits illustrated in FIG. 4A are described.

The transistor 151 serves as a display selection transistor.

As the liquid crystal layer in the liquid crystal element 152, a liquid crystal layer that transmits light when the voltage applied between the first display electrode and the second display electrode is 0 V can be used. For example, it is possible to use a liquid crystal layer including electrically controlled birefringence liquid crystal (ECB liquid crystal), liquid crystal to which dichroic dye is added (GH liquid crystal), polymer-dispersed liquid crystal, or discotic liquid crystal. Alternatively, a liquid crystal layer exhibiting a blue phase may be used. The liquid crystal layer exhibiting a blue phase contains, for example, a liquid crystal composition including a liquid crystal exhibiting a blue phase and a chiral agent. The liquid crystal exhibiting a blue phase has a short response time of 1 msec or less and is optically isotropic; therefore, alignment treatment is not necessary and viewing angle dependence is small. Therefore, with the liquid crystal layer exhibiting a blue phase, the operation speed can be increased. For example, the field-sequential display device in this embodiment needs to have higher operation speed than a display device using a color filter, and therefore, it is preferable that the liquid crystal exhibiting a blue phase be used in the liquid crystal element in the field-sequential display device in this embodiment.

The capacitor 153 serves as a storage capacitor; a voltage corresponding to the signal DD is applied between the first capacitor electrode and the second capacitor electrode in accordance with the transistor 151. The capacitor 153 is not necessarily provided; however, in the case where the capacitor 153 is provided, variations in voltage applied to the liquid crystal element, due to leakage current of the display selection transistor, can be suppressed.

As the transistor 151, for example, it is possible to use a transistor including a semiconductor layer containing a semiconductor belonging to Group 14 of the periodic table (e.g., silicon) or an oxide semiconductor layer, as a layer in which a channel is formed.

Next, an example of a driving method of the display circuit in FIG. 4A is described.

First, an example of a driving method of the display circuit in FIG. 4A is described with reference to FIG. 4B. FIG. 4B is a timing chart for explaining the example of the driving method of the display circuit in FIG. 4A, which shows states of the signal DD and the signal DSEL.

In the example of the driving method of the display circuit in FIG. 4A, the transistor 151 is turned on when a pulse of the signal DSEL is input.

When the transistor 151 is turned on, the signal DD is input to the display circuit, so that the voltage of the first display electrode of the liquid crystal element 152 and the voltage of the first capacitor electrode of the capacitor 153 become equivalent to the voltage of the signal DD.

At this time, the liquid crystal element 152 is put in a writing state (a state wte) and has a light transmittance corresponding to the signal DD, so that the display circuit is put in a display state corresponding to data (each of data D11 to data DQ (Q is a natural number greater than or equal to 2)) of the signal DD.

After that, the transistor 151 is turned off, and the liquid crystal element 152 is put in a holding state (a state hld) and keeps the voltage applied between the first display electrode and the second display electrode so that the amount of variations from the initial value does not exceed a reference value until a pulse of the next signal DSEL is input. Moreover, the light unit in the liquid crystal display device in the above embodiment is lit when the liquid crystal element 152 is in the holding state.

As described with FIG. 4A, the display circuit exemplified in this embodiment includes a display selection transistor and a liquid crystal element. With the above structure, the display circuit can be set in a display state corresponding to a display data signal.

### Embodiment 4

In this embodiment, a transistor that can be applied to the transistor in the liquid crystal display device described in the above embodiment will be described.

As the transistor in the liquid crystal display device described in the above embodiment, for example, it is possible to use a transistor including an oxide semiconductor layer or a semiconductor layer containing a semiconductor that belongs to Group 14 of the periodic table (e.g., silicon), as a layer in which a channel is formed. Note that a layer functioning as a layer in which a channel is formed is also referred to as a channel formation layer.

The semiconductor layer may be a single crystal semiconductor layer, a polycrystalline semiconductor layer, a microcrystalline semiconductor layer, or an amorphous semiconductor layer.

Another example of a transistor including an oxide semiconductor layer, which is applicable to the liquid crystal display device described in the above embodiment, is a transistor including an oxide semiconductor layer that is highly purified. Note that high purification is a general idea including the followings: to remove hydrogen or water in an oxide semiconductor layer as much as possible; and to supply oxygen to an oxide semiconductor layer so as to reduce defects caused by oxygen vacancies in the oxide semiconductor layer.

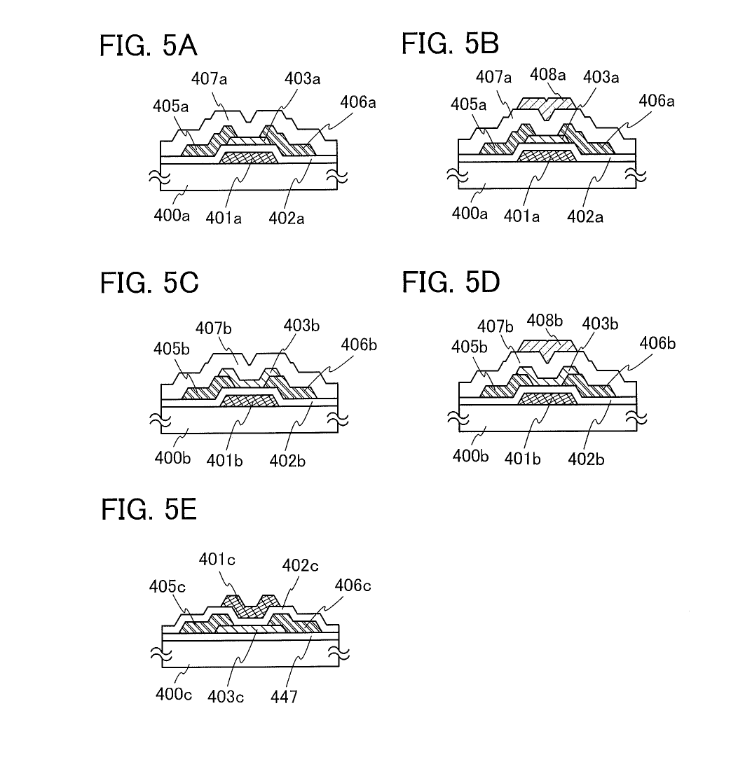

Examples of structures of the transistor including the oxide semiconductor layer are described with reference to FIGS. 5A to 5E. FIGS. 5A to 5E are schematic cross-sectional views each illustrating an example of a structure of a transistor in this embodiment.

A transistor illustrated in FIG. 5A is one of bottom-gate transistors, which is also referred to as an inverted staggered transistor.

The transistor illustrated in FIG. 5A includes a conductive layer 401a, an insulating layer 402a, an oxide semiconductor layer 403a, a conductive layer 405a, and a conductive layer 406a.

The conductive layer 401a is provided over a substrate 400a.

The insulating layer 402a is provided over the conductive layer 401a.

The oxide semiconductor layer 403a overlaps with the conductive layer 401a with the insulating layer 402a interposed therebetween.

The conductive layer 405a and the conductive layer 406a are provided over parts of the oxide semiconductor layer 403a.

Further, in the transistor illustrated in FIG. 5A, an insulating layer 407a is in contact with part of a top surface of the oxide semiconductor layer 403a (part of the oxide semiconductor layer 403a over which neither the conductive layer 405a nor the conductive layer 406a is provided).

The insulating layer 407a is partly in contact with the insulating layer 402a. The conductive layer 405a, the conductive layer 406a, and the oxide semiconductor layer 403a are interposed between the insulating layer 407a and the insulating layer 402a.

A transistor illustrated in FIG. 5B includes a conductive layer 408a in addition to the structure of FIG. 5A.

The conductive layer 408a overlaps with the oxide semiconductor layer 403a with the insulating layer 407a interposed therebetween.

A transistor illustrated in FIG. 5C is one of bottom-gate transistors.

The transistor illustrated in FIG. 5C includes a conductive layer 401b, an insulating layer 402b, an oxide semiconductor layer 403b, a conductive layer 405b, and a conductive layer 406b.

The conductive layer 401b is provided over a substrate 400b.

The insulating layer 402b is provided over the conductive layer 401b.

The conductive layer 405b and the conductive layer 406b are provided over parts of the insulating layer 402b.

The oxide semiconductor layer 403b overlaps with the conductive layer 401b with the insulating layer 402b interposed therebetween.

Further, in FIG. 5C, an insulating layer 407b is provided to be in contact with an upper surface and a side surface of the oxide semiconductor layer 403b of the transistor.

Further, the insulating layer 407b is partly in contact with the insulating layer 402b. The conductive layer 405b, the conductive layer 406b, and the oxide semiconductor layer 403b are interposed between the insulating layer 407b and the insulating layer 402b.

Note that a protective insulating layer may be provided over the insulating layer in FIGS. 5A and 5C.

A transistor illustrated in FIG. 5D includes a conductive layer 408b in addition to the structure of FIG. 5C.

The conductive layer 408b overlaps with the oxide semiconductor layer 403b with the insulating layer 407b interposed therebetween.

A transistor illustrated in FIG. 5E is one of top-gate transistors.

The transistor illustrated in FIG. 5E includes a conductive layer 401c, an insulating layer 402c, an oxide semiconductor layer 403c, a conductive layer 405c, and a conductive layer 406c.

The oxide semiconductor layer 403c is provided over a substrate 400c with an insulating layer 447 interposed therebetween.

The conductive layer 405c and the conductive layer 406c are provided over parts of the oxide semiconductor layer 403c.

The insulating layer 402c is provided over the oxide semiconductor layer 403c, the conductive layer 405c, and the conductive layer 406c.

The conductive layer 401c overlaps with the oxide semiconductor layer 403c with the insulating layer 402c interposed therebetween.

Further, the components illustrated in FIGS. 5A to 5E are described.

Each of the substrates 400a to 400c can be, for example, a light-transmitting substrate such as a glass substrate or a plastic substrate.

Each of the conductive layers 401a to 401c functions as a gate of the transistor. Note that a layer functioning as a gate, of the transistor also referred to as a gate electrode or a gate wiring.

Each of the conductive layers 401a to 401c can be, for example, a layer of a metal material such as molybdenum, titanium, chromium, tantalum, tungsten, aluminum, copper, neodymium, or scandium; or an alloy material containing any of these materials as a main component. The conductive layers 401a to 401c can also be formed by stacking layers of materials which can be applied to the conductive layers 401a to 401c.

Each of the insulating layers 402a to 402c functions as a gate insulating layer of the transistor. Note that a layer functioning as a gate insulating layer of the transistor can be called a gate insulating layer.

As each of the insulating layers 402a to 402c, a silicon oxide layer, a silicon nitride layer, a silicon oxynitride layer, a silicon nitride oxide layer, an aluminum oxide layer, an aluminum nitride layer, an aluminum oxynitride layer, an aluminum nitride oxide layer, or a hafnium oxide layer can be used, for example. The insulating layers 402a to 402c can also be formed by stacking layers of materials that can be used for the insulating layers 402a to 402c.

Alternatively, as the insulating layers 402a to 402c, an insulating layer including a material containing an oxygen element and an element belonging to Group 13 can be used, for example. In the case where the oxide semiconductor layers 403a to 403c contain an element belonging to Group 13, an insulating layer containing an element belonging to Group 13 is used as an insulating layer which is in contact with the oxide semiconductor layers 403a to 403c, whereby an interface between the insulating layer and the oxide semiconductor layer can have a favorable state.

As a material including an element belonging to Group 13, gallium oxide, aluminum oxide, aluminum gallium oxide, gallium aluminum oxide, or the like can be given for example. Here, aluminum gallium oxide refers to a material in which the amount of aluminum (at. %) is larger than that of gallium (at. %), and gallium aluminum oxide refers to a material in which the amount of gallium (at. %) is larger than or equal to that of aluminum (at. %).

For example, an insulating layer containing gallium oxide is used as the insulating layers 402a to 402c, whereby the accumulation amount of hydrogen or hydrogen ions at interfaces between the insulating layers 402a to 402c and the oxide semiconductor layers 403a to 403c can be reduced.

Alternatively, an insulating layer including aluminum oxide is used as the insulating layers 402a to 402c, whereby the accumulation amount of hydrogen or hydrogen ions at interfaces between the insulating layers 402a to 402c and the oxide semiconductor layers 403a to 403c can be reduced. Water does not easily pass through an insulating layer including aluminum oxide. Thus, by using the insulating layer including aluminum oxide, entry of water into the oxide semiconductor layer through the insulating layer can be suppressed.

Further alternatively, as the insulating layers 402a to 402c, a material represented by Al₂Oₓ (x=3+α, and α is α value larger than 0 and less than 1), Ga₂Oₓ (x=3+α, and α is α value larger than 0 and less than 1), GaₓAl₂₋ₓO_{3+α} (x is a value larger than 0 and less than 2, and α is larger than 0 and less than 1), or the like can be used. The insulating layers 402a to 402c can also be formed by stacking layers of materials that can be applied to the insulating layers 402a to 402c. For example, the insulating layers 402a to 402c may be formed by stacking a plurality of different layers which including gallium oxide represented by Ga₂Oₓ. Alternatively, the insulating layers 402a to 402c may be formed by stacking an insulating layer including gallium oxide represented by Ga₂Oₓ and an insulating layer including aluminum oxide represented by Al₂Oₓ.

The insulating layer 447 functions as a base layer preventing diffusion of an impurity element from the substrate 400c.

As the insulating layer 447, a layer of a material which can be applied to the insulating layers 402a to 402c can be used, for example. Alternatively, the insulating layer 447 may be formed by stacking layers of materials that can be applied to the insulating layers 402a to 402c.

Each of the oxide semiconductor layers 403a to 403c functions as a layer in which a channel of the transistor is formed. Note that a layer functioning as a layer in which a channel of the transistor is formed is also referred to as a channel formation layer. As an oxide semiconductor which can be used for the oxide semiconductor layers 403a to 403c, for example, an oxide of four metal elements, an oxide of three metal elements, an oxide of two metal elements, or the like can be given. As the oxide of four metal elements, an In—Sn—Ga—Zn—O-based metal oxide or the like can be used, for example. As the oxide of three metal elements, an In—Ga—Zn—O-based metal oxide, an In—Sn—Zn—O-based metal oxide, an In—Al—Zn—O-based metal oxide, a Sn—Ga—Zn—O-based metal oxide, an Al—Ga—Zn—O-based metal oxide, a Sn—Al—Zn—O-based metal oxide, or the like can be used, for example. As the oxide of two metal elements, an In—Zn—O-based metal oxide, a Sn—Zn—O-based metal oxide, an Al—Zn—O-based metal oxide, a Zn—Mg—O-based metal oxide, a Sn—Mg—O-based metal oxide, an In—Mg—O-based metal oxide, an In—Sn—O-based metal oxide, or an In—Ga—O-based metal oxide can be used, for example. In addition, an In—O-based metal oxide, a Sn—O-based metal oxide, a Zn—O-based metal oxide, or the like can also be used as the oxide semiconductor, for example. Further, the metal oxide that can be used as the oxide semiconductor may contain silicon oxide.

In the case of using an In—Zn—O-based metal oxide, for example, an oxide target which has a composition ratio of In:Zn=50:1 to 1:2 (In₂O₃:ZnO=25:1 to 1:4 expressed in a molar ratio), preferably In:Zn=20:1 to 1:1 (In₂O₃:ZnO=10:1 to 1:2 expressed in a molar ratio), further preferably In:Zn=15:1 to 1.5:1 (In₂O₃:ZnO=15:2 to 3:4 expressed in a molar ratio) can be used for formation of the In—Zn—O-based metal oxide semiconductor layer. For example, when the atomic ratio of the target used for the deposition of the In—Zn—O-based oxide semiconductor is expressed by In:Zn:O═P:U:R, R>1.5P+U. An increase in the amount of indium enables mobility of the transistor to increase.

As the oxide semiconductor, a material represented by InMO₃(ZnO)ₘ (in is larger than 0) can also be used. Here, M in InMO₃(ZnO)ₘ represents one or more metal elements selected from Ga, Al, Mn, or Co.

The conductive layers 405a to 405c and the conductive layers 406a to 406c function as a source or a drain of the transistor. Note that a layer functioning as a source of the transistor can be called a source electrode or a source wiring, and a layer functioning as a drain of the transistor can be called a drain electrode or a drain wiring.

Each of the conductive layers 405a to 405c and the conductive layers 406a to 406c can be, for example, a layer of a metal material such as aluminum, chromium, copper, tantalum, titanium, molybdenum, or tungsten; or an alloy material containing any of these metal materials as a main component. Alternatively, each of the conductive layers 405a to 405c and the conductive layers 406a to 406c can be a stack of layers of materials applicable to the conductive layers 405a to 405c and the conductive layers 406a to 406c.

Alternatively, the conductive layers 405a to 405c and the conductive layers 406a to 406c can be formed using a layer containing conductive metal oxide. Examples of the conductive metal oxide are indium oxide, tin oxide, zinc oxide, an alloy of indium oxide and tin oxide, and an alloy of indium oxide and zinc oxide. Note that the conductive metal oxide applicable to the conductive layers 405a to 405c and the conductive layers 406a to 406c may contain silicon oxide.

Like the insulating layers 402a to 402c, each of the insulating layers 407a and 407b can be an insulating layer including a material containing an oxygen element and an element belonging to Group 13 of the periodic table, for example. Alternatively, for the insulating layers 407a and 407b, for example, a material represented by Al₂Oₓ, Ga₂Oₓ, or GaₓAl₂₋ₓO_{3+α} can be used.

For example, the insulating layers 402a to 402c and the insulating layers 407a and 407b may each be an insulating layer including gallium oxide represented by Ga₂Oₓ. Further, one of the insulating layer (the insulating layers 402a to 402c) and the insulating layer (the insulating layers 407a and 407b) may be an insulating layer including gallium oxide represented by Ga₂Oₓ, and the other of the insulating layer (the insulating layers 402a to 402c) and the insulating layer (the insulating layers 407a and 407b) may be an insulating layer including aluminum oxide represented by Al₂Oₓ.

Each of the conductive layers 408a and 408b functions as a gate of the transistor. When the transistor includes the conductive layer 408a or the conductive layer 408b, one of the conductive layer 401a and the conductive layer 408a or the one of the conductive layer 401b and the conductive layer 408b is referred to as a back gate, a back-gate electrode, or a back-gate wiring. A plurality of layers functioning as a gate are provided with the channel formation layer interposed therebetween, whereby the threshold voltage of the transistor can be controlled.

Each of the conductive layers 408a and 408b can be, for example, a layer of a metal material such as aluminum, chromium, copper, tantalum, titanium, molybdenum, or tungsten; or an alloy material which contains any of the above metal materials as a main component. Each of the conductive layers 408a and 408b can be formed by stacking materials applicable to the conductive layers 408a and 408b.

Alternatively, as the conductive layers 408a and 408b, a layer including conductive metal oxide can be used. Examples of the conductive metal oxide are indium oxide, tin oxide, zinc oxide, an alloy of indium oxide and tin oxide, and an alloy of indium oxide and zinc oxide. Note that the conductive metal oxide applicable to the conductive layers 408a and 408b may contain silicon oxide.

Note that the transistor of this embodiment may have a structure in which an insulating layer is provided over part of the oxide semiconductor layer functioning as a channel formation layer and a conductive layer functioning as a source or a drain is provided to overlap with the oxide semiconductor layer with the insulating layer interposed therebetween. In the above structure, the insulating layer functions as a layer protecting a channel formation layer (also referred to as a channel protective layer) of the transistor. As the insulating layer functioning as a channel protective layer, a layer including a material applicable to the insulating layers 402a to 402c can be used for example. Alternatively, an insulating layer functioning as a channel protective layer may be formed by stacking materials applicable to the insulating layers 402a to 402c.

Note that the transistor in this embodiment does not necessarily have the structure where the entire oxide semiconductor layer overlaps with the conductive layer functioning as a gate electrode, as illustrated in FIGS. 5A to 5E; in the case of employing the structure where the entire oxide semiconductor layer overlaps with the conductive layer functioning as a gate electrode, entry of light into the oxide semiconductor layer can be prevented.

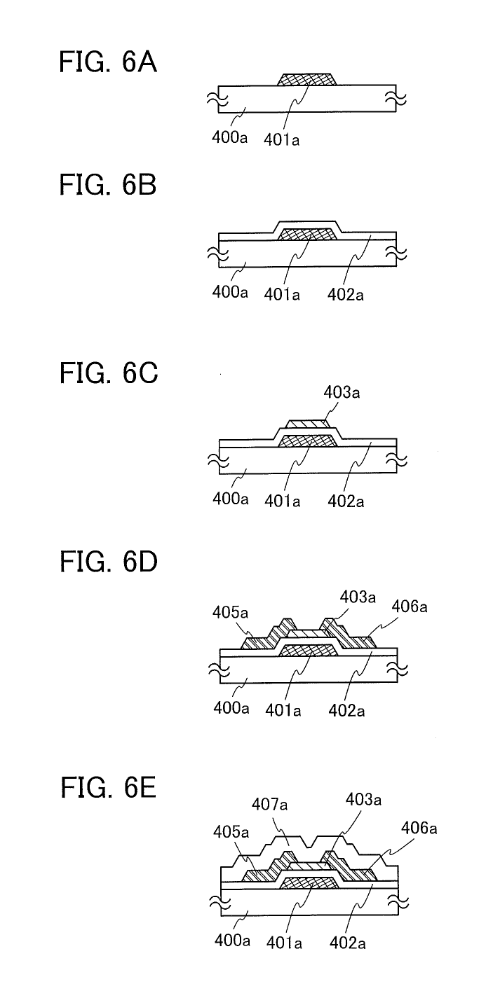

Next, as an example of a method for manufacturing the transistor in this embodiment, an example of a method for manufacturing the transistor illustrated in FIG. 5A will be described with reference to FIGS. 6A to 6E. FIGS. 6A to 6E are schematic cross-sectional views illustrating an example of a method for manufacturing the transistor in FIG. 5A.

First, as illustrated in FIG. 6A, the substrate 400a is prepared, a first conductive film is formed over the substrate 400a, and part of the first conductive film is etched to form the conductive layer 401a.

For example, the first conductive film can be formed by formation of a film of a material applicable to the conductive layer 401a by sputtering. The first conductive film can be formed by stacking layers of materials that can be used for the first conductive film.

When a high-purity gas from which impurities such as hydrogen, water, a hydroxyl group, or a hydride are removed is used as a sputtering gas, the impurity concentration of a film to be formed can be reduced.

Note that before the film is formed by sputtering, preheat treatment may be performed in a preheating chamber of a sputtering apparatus. By the preheat treatment, impurities such as hydrogen or moisture can be eliminated.

Moreover, before the film is formed by sputtering, it is possible to perform the following treatment (called reverse sputtering): instead of applying a voltage to the target side, an RF power source is used for applying a voltage to the substrate side in an argon, nitrogen, helium, or oxygen atmosphere so that plasma is generated to modify a surface where the film is to be formed. With reverse sputtering, powdery substances (also referred to as particles or dust) attached to the surface where the film is to be formed can be removed.

In the case where the film is formed by sputtering, moisture remaining in a deposition chamber used for forming the film can be removed with an entrapment vacuum pump or the like. As the entrapment vacuum pump, a cryopump, an ion pump, a titanium sublimation pump, or the like can be used, for example. Moreover, moisture remaining in the deposition chamber can be removed with a turbo molecular pump provided with a cold trap.

Like a formation of the above conductive layer 401a, in the case where a layer is formed by etching part of a film in an example of a formation method of the transistor in this embodiment, for example, a resist mask is formed over part of the film by a photolithography step, and the film is etched with use of the resist mask, whereby the layer can be formed. In that case, the resist mask is removed after the layer is formed.

Note that the resist mask may be formed by an inkjet method. A photomask is not used in an inkjet method; thus, manufacturing cost can be reduced. Alternatively, the resist mask may be formed using a light-exposure mask having a plurality of regions with different transmittances (also referred to as a multi-tone mask). With a multi-tone mask, a resist mask having regions with different thicknesses can be formed, and the number of resist masks used for manufacturing the transistor can be reduced.

Next, as illustrated in FIG. 6B, the insulating layer 402a is formed by formation of a first insulating film over the conductive layer 401a.

For example, the first insulating film can be formed by formation of a film of a material applicable to the insulating layer 402a by sputtering, plasma CVD, or the like. The first insulating film can also be formed by stacking films of materials that can be used for the insulating layer 402a. Moreover, when a film of a material applicable to the insulating layer 402a is formed by high-density plasma CVD (e.g., high-density plasma CVD using microwaves such as microwave at a frequency of 2.45 GHz), the insulating layer 402a can be dense and have an improved breakdown voltage.

Next, an oxide semiconductor film is formed over the insulating layer 402a and then part of the oxide semiconductor film is etched, whereby the oxide semiconductor layer 403a is formed as illustrated in FIG. 6C.

For example, the oxide semiconductor film can be formed by formation of a film of an oxide semiconductor material applicable to the oxide semiconductor layer 403a by sputtering. Note that the oxide semiconductor film may be formed in a rare gas atmosphere, an oxygen atmosphere, or a mixed atmosphere of a rare gas and oxygen.

The oxide semiconductor film can be formed using an oxide target having a composition ratio of In₂O₃:Ga₂O₃:ZnO=1:1:1 [molar ratio] as a sputtering target. Alternatively, the oxide semiconductor film may be formed using an oxide target having a composition ratio of In₂O₃:Ga₂O₃:ZnO=1:1:2 [molar ratio] as a sputtering target, for example.

When the oxide semiconductor film is formed by sputtering, the substrate 400a may be placed under reduced pressure and heated at the temperature higher than or equal to 100° C. and lower than or equal to 600° C., preferably higher than or equal to 200° C. and lower than or equal to 400° C. By heating the substrate 400a, the concentration of impurities in the oxide semiconductor film can be reduced and damage to the oxide semiconductor film caused by the sputtering can be reduced.

Next, as illustrated in FIG. 6D, a second conductive film is formed over the insulating layer 402a and the oxide semiconductor layer 403a, and part of the second conductive film is etched to form the conductive layers 405a and 406a.

For example, the second conductive film can be formed by formation of a film of a material applicable to the conductive layers 405a and 406a by sputtering or the like. Alternatively, the second conductive film can be formed by stacking films of materials applicable to the conductive layers 405a and 406a.

Then, as illustrated in FIG. 6E, the insulating layer 407a is formed so as to be in contact with the oxide semiconductor layer 403a.

For example, the oxide insulating layer 407a can be formed by formation of a film applicable to the insulating layer 407a by sputtering in a rare gas (typically, argon) atmosphere, an oxygen atmosphere, or a mixed atmosphere of a rare gas and oxygen. The insulating layer 407a formed by sputtering can suppress a reduction in resistance of a portion of the oxide semiconductor layer 403a, which serves as a back channel of the transistor. The temperature of the substrate at the time when the insulating layer 407a is formed preferably ranges from room temperature to 300° C.

Before the formation of the insulating layer 407a, plasma treatment using a gas such as N₂O, N₂, or Ar may be performed to remove water or the like on an exposed surface of the oxide semiconductor layer 403a. In the case of performing the plasma treatment, the insulating layer 407a is preferably formed without exposure to air after the plasma treatment.

Further, in the example of the method for manufacturing the transistor in FIG. 5A, heat treatment is performed, for example, at temperature higher than or equal to 400° C. and lower than or equal to 750° C., or temperature higher than or equal to 400° C. and lower than the strain point of the substrate. For example, the heat treatment is performed after the oxide semiconductor film is formed, after part of the oxide semiconductor film is etched, after the second conductive film is formed, after part of the second conductive film is etched, or after the insulating layer 407a is formed.

A heat treatment apparatus for the heat treatment can be an electric furnace or an apparatus for heating an object by heat conduction or heat radiation from a heating element such as a resistance heating element. For example, a rapid thermal anneal (RTA) apparatus such as a gas rapid thermal anneal (GRTA) apparatus or a lamp rapid thermal anneal (LRTA) apparatus can be used. An LRTA apparatus is an apparatus for heating an object by radiation of light (an electromagnetic wave) emitted from a lamp such as a halogen lamp, a metal halide lamp, a xenon arc lamp, a carbon arc lamp, a high-pressure sodium lamp, or a high-pressure mercury lamp. A GRTA apparatus is an apparatus for heat treatment using a high-temperature gas. As the high-temperature gas, a rare gas or an inert gas (e.g., nitrogen) which does not react with the object by the heat treatment can be used, for example.

Further, after the heat treatment, a high-purity oxygen gas, a high-purity N₂O gas, or ultra-dry air (having a dew point −40° C. or lower, preferably −60° C. or lower) may be introduced in the furnace where the heat treatment has been performed while the heating temperature is being maintained or being decreased. It is preferable that the oxygen gas or the N₂O gas do not contain water, hydrogen, or the like. The purity of the oxygen gas or the N₂O gas which is introduced into the heat treatment apparatus is preferably equal to or more than 6N, further preferably equal to or more than 7N (i.e., the impurity concentration of the oxygen gas or the N₂O gas is preferably equal to or lower than 1 ppm, further preferably equal to or lower than 0.1 ppm). By the action of the oxygen gas or the N₂O gas, oxygen is supplied to the oxide semiconductor layer 403a, so that defects caused by oxygen vacancy in the oxide semiconductor layer 403a can be reduced.

Besides the above heat treatment, heat treatment (preferably at temperature higher than or equal to 200° C. and lower than or equal to 400° C., for example at temperature higher than or equal to 250° C. and lower than or equal to 350° C.) may be performed in an inert gas atmosphere or an oxygen gas atmosphere after the insulating layer 407a is formed.

Oxygen doping using oxygen plasma may be performed after the insulating layer 402a is formed, after the oxide semiconductor film is formed, after the conductive layers functioning as the source electrode and the drain electrode are formed, after the insulating layer is formed, or after the heat treatment is performed. For example, an oxygen doping treatment using a high-density plasma of 2.45 GHz may be performed. Alternatively, oxygen doping may be performed with an ion implantation method or ion doping. The oxygen doping can reduce variations in electrical characteristics of transistors to be manufactured. For example, by performing oxygen doping, one of or both the insulating layer 402a and the insulating layer 407a have oxygen having higher proportion than that in the stoichiometric composition. Thus, excessive oxygen in the insulating layer is easily supplied to the oxide semiconductor layer 403a. As a result, defects of oxygen vacancy in the oxide semiconductor layer 403a or at an interface between the oxide semiconductor layer 403a and one of or both the insulating layer 402a and the insulating layer 407a can be reduced, which results in further reduction in the carrier concentration in the oxide semiconductor layer 403a.

For example, in the case where an insulating layer including gallium oxide is formed as one of or both the insulating layer 402a and the insulating layer 407a, oxygen is supplied to the insulating layer, so that the composition of gallium oxide can be Ga₂Oₓ.

Alternatively, in the case where an insulating layer including aluminum oxide is formed as one of or both the insulating layer 402a and the insulating layer 407a, oxygen is supplied to the insulating layer, so that the composition of aluminum oxide can be Al₂Oₓ.

Alternatively, in the case where an insulating layer including gallium aluminum oxide or aluminum gallium oxide is formed as one of or both the insulating layer 402a and the insulating layer 407a, oxygen is supplied to the insulating layer, so that the composition of gallium aluminum oxide or aluminum gallium oxide can be GaₓAl₂₋ₓO_{3+α}.

Through the above steps, impurities such as hydrogen, water, a hydroxyl group, or a hydride (also referred to as a hydrogen compound) are removed from the oxide semiconductor layer 403a, and in addition, oxygen is supplied to the oxide semiconductor layer 403a, whereby the oxide semiconductor layer can be highly purified.

Although the example of the manufacturing method of the transistor illustrated in FIG. 5A, the manufacturing method of the transistor of the present invention is not limited to the above. For example, if any of the components illustrated in FIGS. 5B to 5E has the same designation as the components in FIG. 5A and has a function, at least part of which is the same as that of the components in FIG. 5A, the description of the example of the manufacturing method of the transistor in FIG. 5A can be employed as appropriate.

As described with FIGS. 5A to 5E and FIGS. 6A to 6E, the transistor exemplified in this embodiment includes a conductive layer functioning as a gate; an insulating layer functioning as a gate insulating layer; an oxide semiconductor layer that overlaps with the conductive layer functioning as the gate with the insulating layer functioning as the gate insulating layer placed therebetween, in which a channel is formed; a conductive layer that is electrically connected to the oxide semiconductor layer and functions as one of a source and a drain; and a conductive layer that is electrically connected to the oxide semiconductor layer and functions as the other of the source and the drain.

Further, in the transistor exemplified in this embodiment, the insulating layer which is in contact with the oxide semiconductor layer and the insulating layer functioning as a gate insulating layer are in contact with each other with the oxide semiconductor layer, the conductive layer functioning as one of a source and a drain, and the conductive layer functioning as the other of the source and the drain interposed therebetween. With the above structure, the oxide semiconductor layer, the conductive layer functioning as one of a source and a drain, and the conductive layer functioning as the other of the source and the drain are surrounded by the insulating layer which is in contact with the oxide semiconductor layer and the insulating layer functioning as a gate insulating layer. Thus, entry of impurities to the oxide semiconductor layer, the conductive layer functioning as one of a source and a drain, and the conductive layer functioning as the other of the source and the drain can be suppressed.

The oxide semiconductor layer in which a channel is formed is an oxide semiconductor layer which is highly purified. By high purification of the oxide semiconductor layer, the carrier concentration of the oxide semiconductor layer can be lower than 1×10¹⁴/cm³, preferably lower than 1×10¹²/cm³, further preferably lower than 1×10¹¹/cm³, and thus, change in characteristics due to temperature change can be suppressed. With the above structure, the off-state current per micrometer of the channel width can be 10 aA (1×10⁻¹⁷ A) or less, 1 aA (1×10⁻¹⁸ A) or less, 10 zA (1×10⁻²⁰ A) or less, further 1 zA (1×10⁻²¹ A) or less, and furthermore 100 yA (1×10⁻²² A) or less. It is preferable that the off-state current of the transistor be as low as possible. The lowest value of the off-state current of the transistor in this embodiment is estimated to be about 10⁻³⁰ A/μm.

The transistor including an oxide semiconductor layer of this embodiment is used for the display circuit, the display selection signal output circuit, or the display data signal output circuit in the liquid crystal display device of the above embodiment, for example, whereby the reliability of the display device can be improved.

### Embodiment 5

In this embodiment, a structural example of the liquid crystal display device described in the above embodiment will be described.

A liquid crystal display device in this embodiment includes a first substrate (an active matrix substrate) where a semiconductor element such as a transistor is provided, a second substrate, and a liquid crystal layer provided between the first substrate and the second substrate.

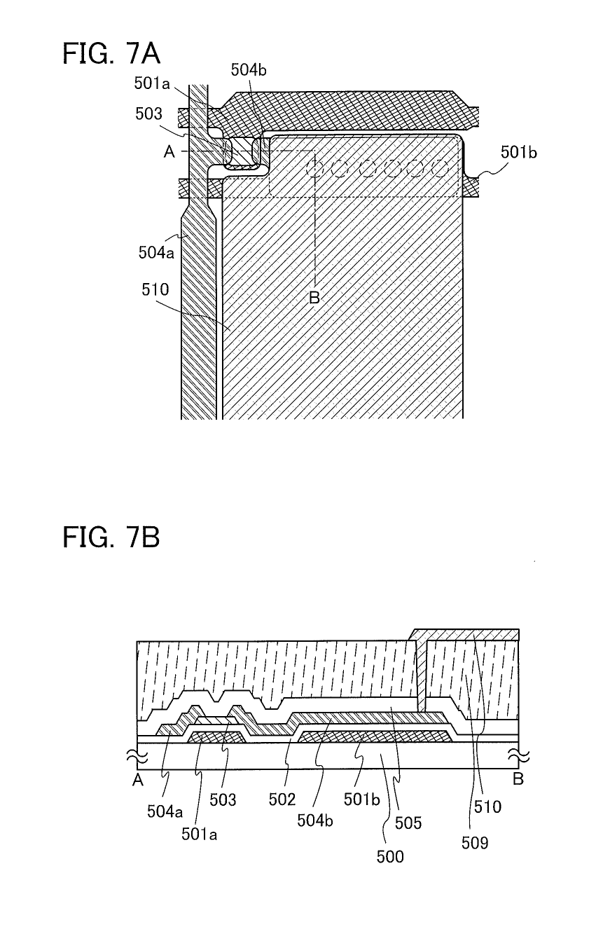

A structural example of the active matrix substrate in the liquid crystal display device of this embodiment is described with reference to FIGS. 7A and 7B. FIGS. 7A and 7B illustrate a structural example of an active matrix substrate in the liquid crystal display device of this embodiment. FIG. 7A is a plan schematic view, and FIG. 7B is a schematic cross-sectional view taken along line A-B in FIG. 7A. In FIGS. 7A and 7B, as an example of the transistor, the transistor having a structure described with FIG. 5A is shown.

The active matrix substrate illustrated in FIGS. 7A and 7B includes a substrate 500, a conductive layer 501a, a conductive layer 501b, an insulating layer 502, a semiconductor layer 503, a conductive layer 504a, a conductive layer 504b, an insulating layer 505, an insulating layer 509, and a conductive layer 510.

Each of the conductive layers 501a and 501b is formed over one surface of the substrate 500.

The conductive layer 501a functions as a gate of a display selection transistor in a display circuit.

The conductive layer 501b functions as a second capacitor electrode of a storage capacitor in the display circuit. Note that the layer functioning as a second capacitor electrode of a capacitor (a storage capacitor) is also referred to as a second capacitor electrode.

The insulating layer 502 is provided over the one surface of the substrate 500 with the conductive layers 501a and 501b placed therebetween.

The insulating layer 502 functions as a gate insulating layer of the display selection transistor in the display circuit and a dielectric layer of the storage capacitor in the display circuit.

The semiconductor layer 503 overlaps with the conductive layer 501a with the insulating layer 502 interposed therebetween. The semiconductor layer 503 functions as a channel formation layer of the display selection transistor in the display circuit.

The conductive layer 504a is electrically connected to the semiconductor layer 503. The conductive layer 504a functions as one of a source and a drain of the display selection transistor in the display circuit.

The conductive layer 504b is electrically connected to the semiconductor layer 503 and overlaps with the conductive layer 501b with the insulating layer 502 interposed therebetween. The conductive layer 504b functions as the other of the source and the drain of the display selection transistor in the display circuit and also functions as a first capacitor electrode of the storage capacitor in the display circuit.

The insulating layer 505 is partly in contact with the semiconductor layer 503. The conductive layers 504a and 504b are interposed between the insulating layer 505 and the semiconductor layer 503.

The insulating layer 509 overlaps with the insulating layer 505. The insulating layer 509 functions as a planarization insulating layer in the display circuit. Note that the insulating layer 509 is not necessarily provided.

The conductive layer 510 is electrically connected to the conductive layer 504b in an opening portion that penetrates the insulating layers 505 and 509. The conductive layer 510 functions as a pixel electrode of a display element in the display circuit. Note that a layer having a function of a pixel electrode can be referred to as a pixel electrode.

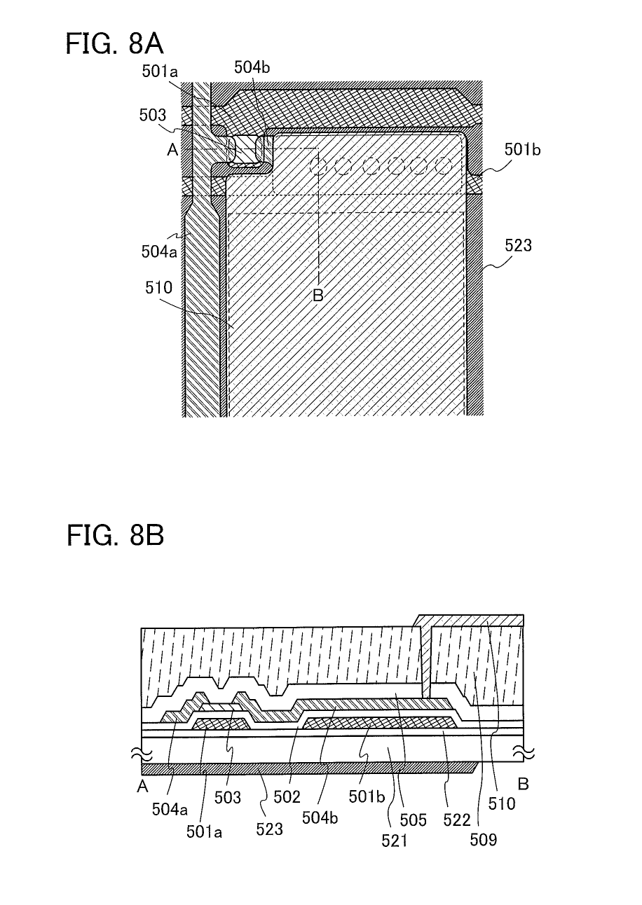

Another structural example of an active matrix substrate in a liquid crystal display device of this embodiment is described with reference to FIGS. 8A and 8B. FIGS. 8A and 8B illustrate a structural example of the active matrix substrate in the liquid crystal display device of this embodiment. FIG. 8A is a plan schematic view, and FIG. 8B is a schematic cross-sectional view taken along line A-B in FIG. 8A. In FIGS. 8A and 8B, as an example of the transistor, the transistor having a structure described with FIG. 5A is shown.

A different point of a structure of the active matrix substrate illustrated in FIGS. 8A and 8B from the structure of the active matrix substrate illustrated in FIGS. 7A and 7B is that a substrate 521 is provided instead of the substrate 500 and an adhesive layer 522 and a reinforcing material 523 are included. Note that in description of the structure of the active matrix substrate in FIGS. 8A and 8B, the description of the active matrix substrate in FIGS. 7A and 7B is employed as appropriate for the portion in FIGS. 8A and 8B the same as that of the active matrix substrate in FIGS. 7A and 7B.

The conductive layer 501a and the conductive layer 501b are formed over a first surface of the substrate 521 with the adhesive layer 522 interposed therebetween.

The reinforcing material 523 is provided on part of a second surface opposite to the first surface of the substrate 521. The part of the second surface indicates a portion other than a portion through which light is transmitted. Note that a base layer may be provided between the adhesive layer 522 and the conductive layers 501a and 501b, and the reinforcing material 523 may be provided between the base layer and the adhesive layer 522. Although the reinforcing material 523 is not necessarily provided for the active matrix substrate in the liquid crystal display device of this embodiment, providing the reinforcing material 523 can increase resistance against impact by an external force, which results in suppression of breakage of the liquid crystal display device.

An example of a manufacturing method of the active matrix substrate in FIGS. 8A and 8B is described. First, a layer to be separated (including the conductive layer 501a, the conductive layer 501b, the insulating layer 502, the semiconductor layer 503, the conductive layer 504a, the conductive layer 504b, the insulating layer 505, the insulating layer 509, and the conductive layer 510) is formed over a first surface of a substrate for manufacturing an element, which is different from the substrate 521, with a separation layer interposed therebetween.

As the substrate for manufacturing an element, a substrate applicable to the substrate 400a illustrated in FIG. 5A can be used, for example.

The separation layer formed over the substrate for manufacturing an element can be a layer including a metal material such as molybdenum, titanium, chromium, tantalum, niobium, nickel, cobalt, zirconium, zinc, ruthenium, rhodium, palladium, osmium, iridium, silicon or tungsten, or an alloy material containing any of the above materials as its main component. Alternatively, the separation layer formed over the substrate for manufacturing an element can be formed by stacking materials applicable to the separation layer formed over the substrate for manufacturing an element.

Next, the substrate for manufacturing an element provided with the layer to be separated and a supporting substrate provided with an adhesive layer are attached so that the layer to be separated and the adhesive layer can be in contact with each other. Then, the substrate for manufacturing all element is separated by causing separation between the separation layer and the layer to be separated.

As the supporting substrate, a substrate applicable to the substrate for manufacturing an element can be used, for example.

Note that, with one or combination of laser light irradiation, etching treatment, and a mechanical method (a method using a knife or the like), for example, separation occurs between the separation layer and the layer to be separated, so that the substrate for manufacturing an element is separated.

Next, the substrate 521 provided with the adhesive layer 522 is bonded to a surface of the layer separated from the separation layer.

Next, the reinforcing material 523 is formed on the second surface of the substrate 521.

Then, the supporting substrate is separated by causing separation between the separated layer and the adhesive layer provided for the supporting substrate. This is the example of a manufacturing method of the active matrix substrate illustrated in FIGS. 8A and 8B.

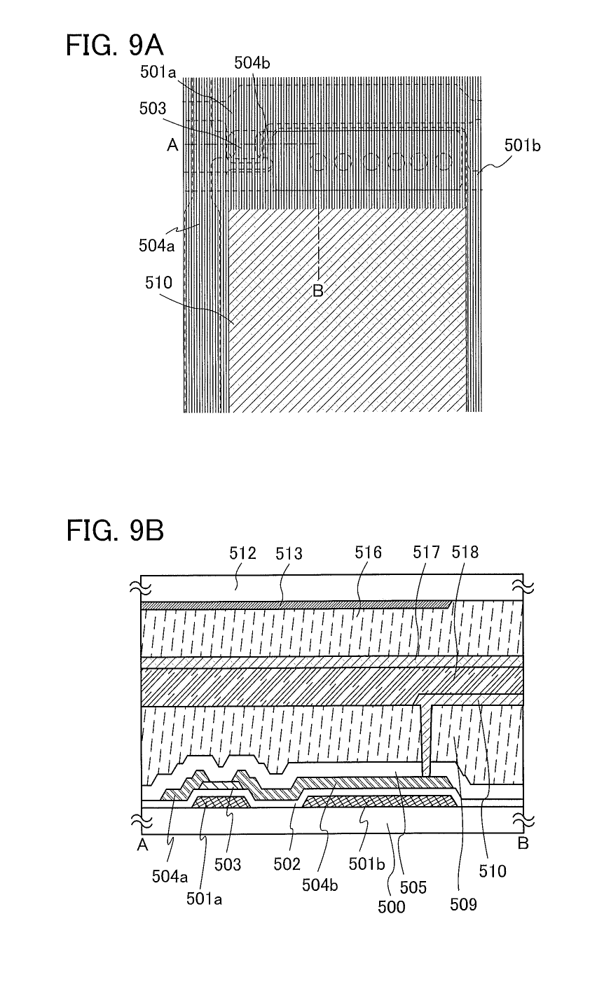

Further, a structural example of a liquid crystal display device in this embodiment is described with reference to FIGS. 9A and 9B. FIGS. 9A and 9B illustrate a structural example of a liquid crystal display device including the active matrix substrate illustrated in FIGS. 7A and 7B. FIG. 9A is a plan schematic view, and FIG. 9B is a schematic cross-sectional view taken along line A-B in FIG. 9A. Note that a display element is used as a liquid crystal element as an example.

The liquid crystal display device illustrated in FIGS. 9A and 9B includes, in addition to the active matrix substrate in FIGS. 7A and 7B, a substrate 512, a light-blocking layer 513, an insulating layer 516, a conductive layer 517, and a liquid crystal layer 518. Note that in FIG. 9A, the conductive layer 517 is omitted for convenience.

The light-blocking layer 513 is provided on part of one surface of the substrate 512. For example, the light-blocking layer 513 is formed on part of the one surface of the substrate 512 except a portion overlapping with the transistor.

The insulating layer 516 is formed on the substrate 512 side so that the light-blocking layer 513 is sandwiched between the insulating layer 516 and the substrate 512.

The conductive layer 517 is provided on the one surface of the substrate 512 side. The conductive layer 517 functions as a common electrode of the display circuit.

The liquid crystal layer 518 is provided between the conductive layer 510 and the conductive layer 517.

The conductive layer 510, the liquid crystal layer 518, and the conductive layer 517 function as a display element in the display circuit.

In addition, components of the liquid crystal display devices illustrated in FIGS. 7A and 7B, FIGS. 8A and 8B, and FIGS. 9A and 9B are described.

As the substrate 500 and the substrate 512, a substrate which can be applied to the substrate 400a in FIG. 5A can be used.

As each of the conductive layer 501a and the conductive layer 501b, a layer whose material is applicable to the conductive layer 401a in FIG. 5A can be used. Alternatively, the conductive layers 501a and 501b may be formed by stacking layers of materials applicable to the conductive layer 401a.

As the insulating layer 502, a layer whose material is applicable to the insulating layer 402a in FIG. 5A can be used. Alternatively, the insulating layer 502 may be formed by stacking layers whose materials are applicable to the insulating layer 402a.

As the semiconductor layer 503, a layer whose material is applicable to the oxide semiconductor layer 403a in FIG. 5A or a semiconductor layer including a semiconductor belonging to Group 14 such as silicon can be used.

As the conductive layers 504a and 504b, a layer whose material is applicable to the conductive layer 405a or the conductive layer 406a in FIG. 5A can be used. Alternatively, the conductive layers 504a and 504b may be formed by stacking layers of materials applicable to the conductive layer 405a or the conductive layer 406a.

As the insulating layer 505, a layer whose material is applicable to the insulating layer 407a in FIG. 5A can be used. Alternatively, the insulating layer 505 may be formed by stacking layers of materials applicable to the insulating layer 407a.

As each of the insulating layer 509 and the insulating layer 516, a layer of an organic material such as polyimide, acrylic, or benzocyclobutene can be used, for example. Alternatively, as the insulating layer 509, a layer of a low-dielectric constant material (also referred to as a low-k material) can be used.

As the conductive layer 510 and the conductive layer 517, for example, it is possible to use a layer of a light-transmitting conductive material such as indium tin oxide, a metal oxide in which zinc oxide is mixed in indium oxide (referred to as indium zinc oxide (IZO)), a conductive material in which silicon oxide (SiO₂) is mixed in indium oxide, organoindium, organotin, indium oxide containing tungsten oxide, indium zinc oxide containing tungsten oxide, indium oxide containing titanium oxide, or indium tin oxide containing titanium oxide. A conductive composition containing a conductive high molecule (also referred to as a conductive polymer) can be used to form the conductive layer 510. A conductive layer formed using the conductive composition preferably has a sheet resistance of 10000 ohms or less per square and a transmittance of 70% or more at a wavelength of 550 nm. Furthermore, the resistivity of the conductive high molecule contained in the conductive composition is preferably 0.1 Ω·cm or less.

As the conductive high molecule, a so-called π-electron conjugated conductive polymer can be used. As the π-electron conjugated conductive polymer, polyaniline or a derivative thereof, polypyrrole or a derivative thereof, polythiophene or a derivative thereof, or a copolymer of two or more of aniline, pyrrole, and thiophene or a derivative thereof can be given, for example.

As the light-blocking layer 513, a layer including a metal material can be used, for example.

For the liquid crystal layer 518, for example, a layer including TN liquid crystal, OCB liquid crystal, STN liquid crystal, VA liquid crystal, ECB liquid crystal, GH liquid crystal, polymer dispersed liquid crystal, discotic liquid crystal, or the like can be used.

As the substrate 521, a substrate having high toughness and a light-transmitting property with respect to visible light can be used. For example, as the substrate 521, a substrate formed using any of the following resins can be used; a polyester resin, an acrylic resin, a polyacrylonitrile resin, a polyimide resin, a polymethyl methacrylate resin, a polycarbonate (PC) resin, a polyethersulfone (PES) resin, a polyamide resin, a cycloolefin resin, a polystyrene resin, a polyamide imide resin, or a polyvinylchloride resin. With use of a substrate formed using any of the above organic resins, the weight of the liquid crystal display device can be reduced, and resistance against the impact caused by external force can be increased; thus, breakup of the liquid crystal display device can be suppressed.

As the adhesive layer 522, a layer of a resin such as a photocurable resin, a reactive curable resin, or a thermosetting resin can be used, for example.

As the reinforcing material 523, for example, a metal plate or the like can be used.

As described with FIGS. 7A and 7B, FIGS. 8A and 8B, and FIGS. 9A and 9B, the liquid crystal display device of this embodiment includes the active matrix substrate provided with the transistor and the pixel electrode, the counter substrate, and the liquid crystal layer having liquid crystal between the active matrix substrate and the counter substrate.

Further, as described with reference to FIGS. 7A and 7B, FIGS. 8A and 8B, and FIGS. 9A and 9B, in the structural example of the liquid crystal display device of this embodiment, the light-blocking layer is provided in a portion other than a portion through which light is transmitted. With the above structure, light incidence on the transistor provided for the active matrix substrate can be suppressed, for example; thus variation in electric characteristics (such as a threshold voltage) of the transistor due to light can be suppressed.

Further, with the structure of the liquid crystal display device described in this embodiment, a circuit such as a display selection signal output circuit can be provided over a substrate where a display circuit is provided. In this case, the transistor in the circuit such as a display selection signal output circuit may have the same structure as the transistor in the display circuit. With the above structure, the display circuit and the display selection signal output circuit can be formed over one substrate by the same step; thus, defects of connection between the display circuit and the display selection signal output circuit can be reduced.

According to the structure of the liquid crystal display device exemplified in this embodiment, a substrate which is lightweight and has high resistance against the impact can be used as a substrate where an element such as a transistor is formed. Thus, breakup of the liquid crystal display device can be suppressed.

### Embodiment 6

In this embodiment, examples of electronic devices each provided with the liquid crystal display device of the above embodiment will be described.

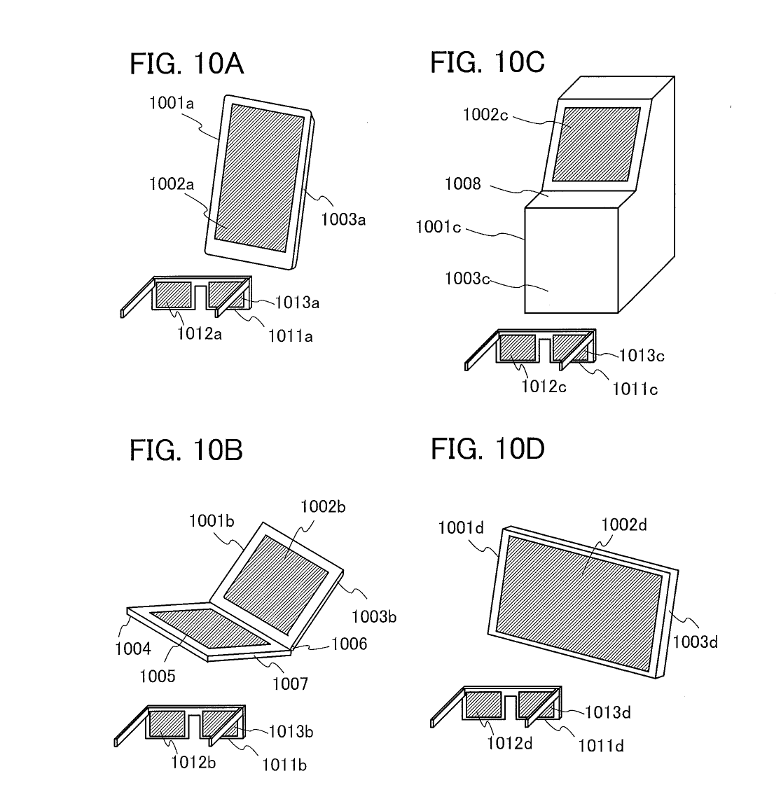

Structural examples of electronic devices of this embodiment are described with reference to FIGS. 10A to 10D. FIGS. 10A to 10D are schematic views illustrating of structural examples of electronic devices of this embodiment.

An electronic device illustrated in FIG. 10A is an example of a portable information terminal. The portable information terminal in FIG. 10A includes a housing 1001a and a display portion 1002a provided in the housing 1001a.

Note that, on a side surface 1003a of the housing 1001a, a connection terminal to which an external device is connected and one or plural buttons for operating the portable information terminal in FIG. 10A may be provided.

In the housing 1001a of the portable information terminal illustrated in FIG. 10A, a CPU, a main memory, an interface with which signals are transmitted/received between the external device and the CPU and the main memory, and an antenna which sends and receives the signals to/from the external device are provided. NOte that in the housing 1001a, one or plural integrated circuits having a specific function may be provided.

An image on the display portion 1002a is seen with use of glasses 1011a with polarization shutters as illustrated in FIG. 10A, whereby a pseudo 3D image can be seen. The glasses 1011a are provided with a polarization shutter 1012a for the left eye and a polarization shutter 1013a for the right eye, and the polarization shutters are formed using liquid crystal. For example, when an image on the display portion 1002a is a left-eye image, light incident on the right eye of a viewer is blocked with the polarization shutter 1013a for the right eye, and when an image on the display portion 1002a is a right-eye image, light incident on the left eye of the viewer is blocked with the polarization shutter 1012a for the left eye. As a result, the viewer can see a pseudo 3D image. Note that an antenna may be provided for the glasses 1011a and receives carrier waves including a control signal by wireless communication, so that light transmittance through the polarization shutter 1012a for the left eye and the polarization shutter 1013a for the right eye is controlled.

The portable information terminal illustrated in FIG. 10A has a function of one or more of a telephone set, an electronic book, a personal computer, and a game machine.

An electronic device illustrated in FIG. 10B is an example of a foldable portable information terminal. The portable information terminal illustrated in FIG. 10B includes a housing 1001b, a display portion 1002b provided in the housing 1001b, a housing 1004, a display portion 1005 provided in the housing 1004, and a hinge 1006 for connecting the housing 1001b and the housing 1004.

In the case of the portable information terminal illustrated in FIG. 10B, the housing 1001b or the housing 1004 is moved with the hinge 1006, whereby the housing 1001b can be stacked over the housing 1004.

Note that on a side surface 1003b of the housing 1001b or a side surface 1007 of the housing 1004, a connection terminal to which an external device is connected and one or plural buttons for operating the portable information terminal in FIG. 10B may be provided.

The display portion 1002b and the display portion 1005 may display different images or one image. Note that the display portion 1005 is not necessarily provided, and a keyboard which is an input device may be provided instead of the display portion 1005.

In the housing 1001b or the housing 1004 of the portable information terminal illustrated in FIG. 10B, a CPU, a main memory, and an interface with which signals are transmitted/received between the external device and the CPU and the main memory are provided. Note that in the housing 1001b or the housing 1004, one or plural integrated circuits having a specific function may be provided. Furthermore, for the portable information terminal illustrated in FIG. 10B, an antenna which sends and receives the signals to/from the external device may be provided.

An image on the display portion 1002b or the display portion 1005 is seen with use of glasses 1011b with polarization shutters as illustrated in FIG. 10B, whereby a pseudo 3D image can be seen. The glasses 1011b are provided with a polarization shutter 1012b for the left eye and a polarization shutter 1013b for the right eye, and the polarization shutters are formed using liquid crystal. For example, when an image on the display portion 1002b or the display portion 1005 is a left-eye image, light incident on the right eye of a viewer is blocked with the polarization shutter 1013b for the right eye, and when an image on the display portion 1002b or the display portion 1005 is a right-eye image, light incident on the left eye of the viewer is blocked with the polarization shutter 1012b for the left eye. As a result, the viewer can see a pseudo 3D image. Note that an antenna may be provided for the glasses 1011b and receives carrier waves including a control signal by wireless communication, so that light transmittance through the polarization shutter 1012b for the left eye and the polarization shutter 1013b for the right eye is controlled.

The portable information terminal illustrated in FIG. 10B has a function of one or more of a telephone set, an electronic book, a personal computer, and a game machine.

An electronic device illustrated in FIG. 10C is an example of a stationary information terminal. The stationary information terminal in FIG. 10C includes a housing 1001c and a display portion 1002c provided in the housing 1001c.

Note that the display portion 1002c can be provided on a deck portion 1008 of the housing 1001c.

In the housing 1001c of the stationary information terminal illustrated in FIG. 10C, a CPU, a main memory, and an interface with which signals are transmitted/received between the external device and the CPU and the main memory are provided. Note that in the housing 1001c, one or plural integrated circuits having a specific function may be provided. Furthermore, for the stationary information terminal illustrated in FIG. 10C, an antenna which sends and receives the signals to/from the external device may be provided.

Further, on a side surface 1003c of the housing 1001c in the stationary information terminal illustrated in FIG. 10C, one or more of a ticket output portion which outputs a ticket or the like, a coin slot, and a bill slot may be provided.

An image on the display portion 1002c is seen with use of glasses 1011c with polarization shutters as illustrated in FIG. 10C, whereby a pseudo 3D image can be seen. The glasses 1011c are provided with a polarization shutter 1012c for the left eye and a polarization shutter 1013c for the right eye, and the polarization shutters are formed using liquid crystal. For example, when an image on the display portion 1002c is a left-eye image, light incident on the right eye of a viewer is blocked with the polarization shutter 1013c for the right eye, and when an image on the display portion 1002c is a right-eye image, light incident on the left eye of the viewer is blocked with the polarization shutter 1012c for the left eye. As a result, the viewer can see a pseudo 3D image. Note that an antenna may be provided for the glasses 1011c and receives carrier waves including a control signal by wireless communication, so that light transmittance through the polarization shutter 1012c for the left eye and the polarization shutter 1013c for the right eye is controlled.

The stationary information terminal illustrated in FIG. 10C has a function of, for example, an automated teller machine, an information communication terminal (also referred to as a multimedia station) for ordering information goods such as a ticket, or a game machine.

An electronic device illustrated in FIG. 10D is an example of a stationary information terminal. The stationary information terminal illustrated in FIG. 10D includes a housing 1001d and a display portion 1002d provided in the housing 1001d. Note that a supporting base which supports the housing 1001d may be provided.

Note that on a side surface 1003d of the housing 1001d, a connection terminal to which an external device is connected and one or plural buttons for operating the stationary information terminal in FIG. 10D may be provided.

In the housing 1001d of the stationary information terminal illustrated in FIG. 10D, a CPU, a main memory, and an interface with which signals are transmitted/received between the external device and the CPU and the main memory may be provided. Further, in the housing 1001d, one or plural integrated circuits having a specific function may be provided. Furthermore, an antenna which sends and receives the signals to/from the external device may be provided in the stationary information terminal illustrated in FIG. 10D.

An image on the display portion 1002d is seen with use of glasses 1011d with polarization shutters as illustrated in FIG. 10D, whereby a pseudo 3D image can be seen. The glasses 1011d are provided with a polarization shutter 1012d for the left eye and a polarization shutter 1013d for the right eye, and the polarization shutters are formed using liquid crystal. For example, when an image on the display portion 1002d is a left-eye image, light incident on the right eye of a viewer is blocked with the polarization shutter 1013d for the right eye, and when an image on the display portion 1002d is a right-eye image, light incident on the left eye of the viewer is blocked with the polarization shutter 1012d for the left eye. As a result, the viewer can see a pseudo 3D image. Note that an antenna may be provided for the glasses 1011d and receives carrier waves including a control signal by wireless communication, so that light transmittance through the polarization shutter 1012d for the left eye and the polarization shutter 1013d for the right eye is controlled.

The stationary information terminal illustrated in FIG. 10D has a function of, for example, a digital photo frame, an output monitor, or a television set.

The liquid crystal display device described in the above embodiment is used for a display portion of an electronic device, and for example, used for the display portions 1002a to 1002d illustrated in FIGS. 10A to 10D. Further, the liquid crystal display device of the above embodiment may be used for the display portion 1005 illustrated in FIG. 10B.

As description with reference to FIGS. 10A to 10D, the example of the electronic device of this embodiment has a structure in which the display portion including the liquid crystal display device described in the above embodiment is provided. With such a structure, an image on the display portion can be seen as a pseudo 3D image.

Further, in the example of the electronic device of this embodiment, the housing may be provided with one or more of a photoelectric conversion portion which generates power supply voltage in accordance with incident illuminance and an operation portion for operating the liquid crystal display device. For example, when the photoelectric conversion portion is provided, an external power supply is not needed; thus, the electronic device can be used for a long time even in an environment where an external power supply is not provided.

### EXPLANATION OF REFERENCE

101: display selection signal output circuit, 102: display data signal output circuit, 104: light unit, 105: display circuit, 151: transistor, 152: liquid crystal element, 153: capacitor, 300: a sequential circuit, 301a: transistor, 301b: transistor, 301c: transistor, 301d: transistor, 301e: transistor, 301f: transistor, 301g: transistor, 301h: transistor, 301i: transistor, 301j: transistor, 301k: transistor, 301l: transistor, 400a: substrate, 400b: substrate, 400c: substrate, 401a: conductive layer, 401b: conductive layer, 401c: conductive layer, 402a: insulating layer, 402b: insulating layer, 402c: insulating layer, 403a: oxide semiconductor layer, 403b: oxide semiconductor layer, 403c: oxide semiconductor layer, 405a: conductive layer, 405b: conductive layer, 405c: conductive layer, 406a: conductive layer, 406b: conductive layer, 406c: conductive layer, 407a: insulating layer, 407b: insulating layer, 408a: conductive layer, 408b: conductive layer, 447: insulating layer, 500: substrate, 501a: conductive layer, 501b: conductive layer, 502: insulating layer, 503: semiconductor layer, 504a: conductive layer, 504b: conductive layer, 505: insulating layer, 509: insulating layer, 510: conductive layer, 512: substrate, 513: light-blocking layer, 516: insulating layer, 517: conductive layer, 518: liquid crystal layer, 521: substrate, 522: adhesive layer, 523: reinforcing material, 1001a: housing, 1001b: housing, 1001c: housing, 1001d: housing, 1002a: display portion, 1002b: display portion, 1002c: display portion, 1002d: display portion, 1003a: side surface, 1003b: side surface, 1003c: side surface, 1003d: side surface, 1004: housing, 1005: display portion, 1006: hinge, 1007: side surface, 1008: deck portion, 1011a: glass, 1011b: glass, 1011c: glass, 1011d: glass, 1012a: polarization shutter for left eye, 1012b: polarization shutter for left eye, 1012c: polarization shutter for left eye, 1012d: polarization shutter for left eye, 1013a: polarization shutter for right eye, 1013b: polarization shutter for right eye, 1013c: polarization shutter for right eye, 1013d: polarization shutter for right eye

This application is based on Japanese Patent Application serial no. 2010-171162 filed with Japan Patent Office on Jul. 29, 2010, the entire contents of which are hereby incorporated by reference.

1. A method for driving a liquid crystal display device comprising a plurality of display circuits arranged in matrix, and a light unit overlapping with the plurality of display circuits and including a plurality of light-emitting diode groups, the method for driving the liquid crystal display device comprising the steps of:
inputting display selection signals to the plurality of display circuits in respective rows;
inputting display data signals to the respective plurality of display circuits in accordance with pulses of the display selection signals; and
displaying a right-eye image or a left-eye image corresponding to data of the display data signal,
wherein light incident on a right eye of a viewer is blocked when data of the display data signal is data for a left eye,
wherein light incident on the left eye of the viewer is blocked when data of the display data signal is data for the right eye,
wherein the data of the display data signal is alternately switched between the data for the left eye and the data for the right eye every a plurality of frame periods including a first frame period and a second frame period just after the first period,
wherein each of the plurality of display circuits comprises a plurality of groups each including the display circuits in at least one row,
wherein each of the plurality of light-emitting diode groups comprises a plurality of light-emitting diodes which emit light of different colors,
wherein the pulses of the display selection signals are sequentially input to the plurality of display circuits in the respective rows in each of the plurality of groups,
wherein a color image is displayed during the second frame period when data of the display data signal input during the first frame period is the data for one eye for which data of the display data signal input during the second frame period,
wherein the color image is displayed by performing the steps of:
making the light-emitting diodes in each of the plurality of light emitting diode groups sequentially emit light every time the pulse of the display selection signal is input to the display circuit in the respective rows, and
emitting light sequentially from the light unit to the display circuits in the respective rows to which the pulses of the display selection signal are input, so that colors of the light emitted by the plurality of light emitting diode groups are different from each other and changed every time the pulse of the display selection signal is input, and
wherein a black image is displayed during the second frame period, when data of the display data signal input during the first frame period is for a different eye from an eye for which data of the display data signal input during the second frame period is.

2. The method for driving a liquid crystal display device according to claim 1,
wherein the plurality of light-emitting diodes provided in each of the plurality of light-emitting diode groups comprises at least a red light-emitting diodes, a green light-emitting diodes, and a blue light-emitting diodes.

3. The method for driving a liquid crystal display device according to claim 1,
wherein the pulses of the display selection signals are sequentially input at least three times to the plurality of display circuits in the respective rows in each of the plurality of groups.

4. The method for driving a liquid crystal display device according to claim 1,
wherein, every time data is switched between the image data for the left eye and the image data for the right eye, the number of colors of light emitted concurrently by the light-emitting diodes in each light-emitting diode group is alternately changed between one color or two colors when the light unit is lit.

5. The method for driving a liquid crystal display device according to claim 1,
wherein each of the plurality of display circuits comprises a liquid crystal element and a transistor for controlling the liquid crystal element, and
wherein a semiconductor layer of the transistor comprises an oxide semiconductor.

6. A method for driving a liquid crystal display device comprising a plurality of display circuits arranged in matrix, and a light unit overlapping with the plurality of display circuits and including a plurality of light-emitting diode groups, the method for driving the liquid crystal display device comprising the steps of:
inputting display selection signals to the plurality of display circuits in respective rows;
inputting display data signals to the respective plurality of display circuits in accordance with pulses of the display selection signals; and
displaying a right-eye image or a left-eye image corresponding to data of the display data signal,
wherein light incident on a right eye of a viewer is blocked when data of the display data signal is data for a left eye,
wherein light incident on the left eye of the viewer is blocked when data of the display data signal is data for the right eye,
wherein the data of the display data signal is alternately switched between the data for the left eye and the data for the right eye every a plurality of frame periods including a first frame period and a second frame period just after the first period,
wherein each of the plurality of display circuits comprises a plurality of groups each including the display circuits in at least one row,
wherein each of the plurality of light-emitting diode groups comprises a plurality of light-emitting diodes which emit light of different colors,
wherein the pulses of the display selection signals are sequentially input to the plurality of display circuits in the respective rows in each of the plurality of groups,
wherein a color image is displayed during the second frame period when data of the display data signal input during the first frame period is the data for one eye for which data of the display data signal input during the second frame period,
wherein the color image is displayed by performing the steps of:
making the light-emitting diodes in each of the plurality of light emitting diode groups sequentially emit light every time the pulse of the display selection signal is input to the display circuit in the respective rows, and
emitting light sequentially from the light unit to the display circuits in the respective rows to which the pulses of the display selection signal are input, so that colors of the light emitted by the plurality of light emitting diode groups are different from each other and changed every time the pulse of the display selection signal is input, and
wherein a display data signal including data of a black image is input to the display circuits during the second frame period, when image data input during the second frame period is for a different eye from an eye for which image data input during the first frame period is.

7. The method for driving a liquid crystal display device according to claim 6,
wherein the plurality of light-emitting diodes provided in each of the plurality of light-emitting diode groups comprises at least a red light-emitting diodes, a green light-emitting diodes, and a blue light-emitting diodes.

8. The method for driving a liquid crystal display device according to claim 6,
wherein the pulses of the display selection signals are sequentially input at least three times to the plurality of display circuits in the respective rows in each of the plurality of groups.

9. The method for driving a liquid crystal display device according to claim 6,
wherein, every time data is switched between the image data for the left eye and the image data for the right eye, the number of colors of light emitted concurrently by the light-emitting diodes in each light-emitting diode group is alternately changed between one color or two colors when the light unit is lit.

10. The method for driving a liquid crystal display device according to claim 6,
wherein each of the plurality of display circuits comprises a liquid crystal element and a transistor for controlling the liquid crystal element, and
wherein a semiconductor layer of the transistor comprises an oxide semiconductor.

11. A method for driving a liquid crystal display device comprising a plurality of display circuits arranged in matrix, and a light unit overlapping with the plurality of display circuits and including a plurality of light-emitting diode groups, the method for driving the liquid crystal display device comprising the steps of:
inputting display selection signals to the plurality of display circuits in respective rows;
inputting display data signals to the respective plurality of display circuits in accordance with pulses of the display selection signals; and
displaying a right-eye image or a left-eye image corresponding to data of the display data signal,
wherein light incident on a right eye of a viewer is blocked when data of the display data signal is data for a left eye,
wherein light incident on the left eye of the viewer is blocked when data of the display data signal is data for the right eye,
wherein the data of the display data signal is alternately switched between the data for the left eye and the data for the right eye every a plurality of frame periods including a first frame period and a second frame period just after the first period,
wherein each of the plurality of display circuits comprises a plurality of groups each including the display circuits in at least one row,
wherein each of the plurality of light-emitting diode groups comprises a plurality of light-emitting diodes which emit light of different colors,
wherein the pulses of the display selection signals are sequentially input to the plurality of display circuits in the respective rows in each of the plurality of groups,
wherein a color image is displayed during the second frame period when data of the display data signal input during the first frame period is the data for one eye for which data of the display data signal input during the second frame period,
wherein the color image is displayed by performing the steps of:
making the light-emitting diodes in each of the plurality of light emitting diode groups sequentially emit light every time the pulse of the display selection signal is input to the display circuit in the respective rows, and
emitting light sequentially from the light unit to the display circuits in the respective rows to which the pulses of the display selection signal are input, so that colors of the light emitted by the plurality of light emitting diode groups are different from each other and changed every time the pulse of the display selection signal is input, and
wherein the light unit is turned off during the second frame period, when image data input during the second frame period is for a different eye from an eye for which image data input during the first frame period is.

12. The method for driving a liquid crystal display device according to claim 11,
wherein the plurality of light-emitting diodes provided in each of the plurality of light-emitting diode groups comprises at least a red light-emitting diodes, a green light-emitting diodes, and a blue light-emitting diodes.

13. The method for driving a liquid crystal display device according to claim 11,
wherein the pulses of the display selection signals are sequentially input at least three times to the plurality of display circuits in the respective rows in each of the plurality of groups.

14. The method for driving a liquid crystal display device according to claim 11,
wherein, every time data is switched between the image data for the left eye and the image data for the right eye, the number of colors of light emitted concurrently by the light-emitting diodes in each light-emitting diode group is alternately changed between one color or two colors when the light unit is lit.

15. The method for driving a liquid crystal display device according to claim 11,
wherein each of the plurality of display circuits comprises a liquid crystal element and a transistor for controlling the liquid crystal element, and
wherein a semiconductor layer of the transistor comprises an oxide semiconductor.
